(19) United States
(12) Patent Application Publication
(10) Pub. No.: US 2026/0235261 A1
(43) Pub. Date: Aug. 13, 2026

(54) APPARATUS AND METHOD FOR DISPENSING A CRYOGENIC LIQUID

(71) Applicant: Air Products and Chemicals, Inc., Allentown, PA (US)

(72) Inventors: Jay A. Thakkar, Allentown, PA (US); Thomas S. Schmidt, Slatington, PA (US); Joseph P. Cohen, Bethlehem, PA (US); Anup Vasant Sane, Allentown, PA (US); Robert Kevin Wagner, Whitehall, PA (US); Jeffrey R. Hufton, Fogelsville, PA (US); Xukun Luo, Allentown, PA (US)

(73) Assignee: Air Products and Chemicals, Inc., Allentown, PA (US)

(21) Appl. No.: 19/050,419

(22) Filed: Feb. 11, 2025

(51) Int. Cl. F17C 6/00

(52) U.S. Cl. CPC F17C 6/00; F17C 2205/037; F17C 2221/012; F17C 2223/0161; F17C 2227/0135; F17C 2227/0337; F17C 2265/034

(57) ABSTRACT

An apparatus and process for dispensing a cryogenic fluid (e.g. a cryogenic liquid, liquid hydrogen, liquid natural gas, etc.) can include feeding liquid from a storage tank to one or more dispenser feed vessels, subsequently pressurizing the vessel(s) with gas to a pre-selected dispending pressure, and then outputting the liquid from the dispenser feed vessel(s) to one or more dispensers. After dispensing is complete, fluid from within the vessel(s) can be displaced and used for other processing. Embodiments can be configured to help limit or avoid venting while also providing improved operational flexibility and efficiency.

### FIELD OF THE INVENTION

The present innovation relates to apparatuses and methods for dispensing a cryogenic liquid (e.g., liquid hydrogen, liquid methane, liquid oxygen, liquid nitrogen, liquid helium, etc.).

### BACKGROUND OF THE INVENTION

Examples of hydrogen generation and supply systems can be appreciated from U.S. Pat. Nos. 6,401,767, 6,474,078, 6,619,336, 6,708,573, 6,745,801, 6,786,245, 7,028,724, 7,328,726, 7,793,675, 7,921,883, 8,020,589, 8,286,675, 8,365,777, 8,453,682, 8,899,278, 9,074,730, 9,151,448, 9,261,238, 9,279,541, 9,404,620, 9,863,583, 10,502,649, and 10,508,770.

Cryogenic fluid dispensing systems typically utilize a pump to feed the fluid toward a device for use of that fluid by that device. Examples of pumps used to help facilitate cryogenic fluid dispensing can be appreciated from U.S. Pat. No. 6,474,078 and U.S. Patent Application Publication No. 2014/0096540.

### SUMMARY OF THE INVENTION

Filling tanks such as vehicle fuel tanks or tanks used to transport a cryogenic liquid (e.g. liquid hydrogen) can be relatively difficult compared to use of the gaseous version of such a fluid due to the extremely cold cryogenic temperatures (e.g. ~20K of such pressurized liquid hydrogen). The pumps utilized in such pressure pumping process may require continuous maintenance, are complex in operation and design, may have long startup time due to temperature requirements, waste hydrogen to maintain temperature, and generate a considerable amount of noise pollution during operation. We have developed embodiments that can facilitate dispensing of a cryogenic fluid (e.g. liquid hydrogen) in a way that can address such issues and avoid use of a pump or limit the need for use of a pump to provide such dispensing. Some embodiments can be configured to utilize a cryogenic gas (e.g. vapor boilup from stored liquid hydrogen, etc.) for use in supplying pressure to pressure pump a cryogenic liquid. We have found that some embodiments can provide simpler dispensing operational designs that can provide reduced maintenance work and improved operational flexibility.

In some embodiments, the liquid cryogenic fluid can be liquid hydrogen that can be provided to a dispenser can be over the critical pressure of hydrogen while simultaneously also being colder than the critical temperature of hydrogen. For other embodiments, the fluid that is utilized may be liquid natural gas, or another suitable cryogenic liquid (e.g. liquid nitrogen, liquid oxygen, liquid argon, etc.) that can be at a cryogenic temperature and embodiments can be configured so that the liquid that is provided to a dispenser may be under its critical temperature but also over its critical pressure. In yet other embodiments, the cryogenic liquid that is utilized may be a cryogenic fluid that can be provided to the dispenser so that the fluid is above its critical temperature and also over its critical pressure. In situations where the cryogenic liquid is above its critical temperature and also over its critical pressure, the cryogenic liquid can be considered a super critical fluid. Such a fluid may have both gas-like and liquid-like properties. As used herein, a super critical fluid is considered a cryogenic liquid (e.g. the term cryogenic liquid includes cryogenic liquids and/or cryogenic super critical fluids).

Some embodiments can be configured to utilize a gaseous hydrogen obtained from vapor that may boil off of stored liquid hydrogen to pressure pump liquid hydrogen using this gaseous hydrogen while simultaneously also attempting to recover and recycle hydrogen gas used for pressurization. Embodiments can be configured to optimize and reduce refrigeration losses as well, which can make embodiments more reliable and more sustainable while also providing improved operational flexibility and efficiency. Embodiments may also permit dispensing operations to occur more quickly.

Some embodiments can permit startup times to be significantly reduced so that there may be no delay in permitting dispensing operations for feeding a cryogenic liquid into a vehicle fuel tank or storage tank or a very minimal delay (e.g., less than 5 seconds, less than 10 seconds, less than 30 seconds, less than 60 seconds etc.).

Embodiments can also help significantly reduce losses associated with friction as well as other mechanical and thermodynamic losses that can occur via substantial use of a pump to drive the flow of the cryogenic fluid to a dispenser. For example, some embodiments can be provided so that a pump is not needed for the dispensing of the cryogenic fluid to the fuel tank or storage tank of a vehicle for filling of the tank or to fill the tank to a substantially filled level. A substantially filled level of the vehicle tank, can be, for example, a level that is at least 90% filled and less than 100% filled, greater than or equal to 95% filled while also being less than 100% filled, greater than or equal to 97% filled and less than 100% filled, or other suitable fill level that is a substantial filling of the vehicle tank (e.g. a significant amount of fuel is provided to the fuel tank without use of a pump so that the fuel tank can be at least 80% filled to 100% filled, a significant amount of cryogenic fluid is provided to the vehicle tank without use of a pump so that the tank can be at least 80% filled to 100% filled, etc.). By avoiding use of a pump or substantial use of a pump, mechanical friction losses and other pump related losses (e.g., fugitive emission of vapor formed from the pumping of the cryogenic fluid, etc.) and inefficiencies can be avoided.

Some embodiments can be configured so that the cryogenic fluid fed to a vehicle fuel tank is a liquid cryogenic fluid (e.g. liquid hydrogen, liquid natural gas, etc.) or is mostly liquid (e.g. at least 90 vol% liquid, at least 95 vol% liquid, etc.). Embodiments can be configured so that gas that may boil-off from a cryogenic liquid stored in a storage tank can be utilized to help drive the flow of the cryogenic liquid to one or more vehicle fuel tanks. Embodiments can be configured to help avoid losses of the cryogenic fluid that may occur as cryogenic liquid is stored (e.g. avoid venting of the boil-up of the gas that can form as the cryogenic liquid is stored in the storage tank). Embodiments may also permit fueling of vehicle fuel tanks to occur more quickly and efficiently.

The vehicle having the fuel tank to be filled by an embodiment of our apparatus or by use of an embodiment of the process can be, for example, a truck, car, bus, boat, drone, rail, aircraft, construction and mining vehicles or other type of vehicle. Such vehicles can be industrial vehicles or large transportation vehicles (e.g., a bus, construction vehicle, a train, an airplane, a ship, a truck for transportation of goods or material, etc.), for example.

Other embodiments can be configured so that the cryogenic fluid fed to a vehicle tank for transportation of the fluid is a liquid cryogenic fluid (e.g. liquid hydrogen, liquid natural gas, liquid oxygen, liquid nitrogen, liquid argon, etc.) or is mostly liquid (e.g. at least 90 vol % liquid, at least 95 vol % liquid, etc.). Embodiments can be configured so that gas that may boil-off from a cryogenic liquid stored in a storage tank can be utilized to help drive the flow of the cryogenic liquid to one or more vehicle tanks. Embodiments can be configured to help avoid losses of the cryogenic fluid that may occur as cryogenic liquid is stored (e.g. avoid venting of the boil-up of the gas that can form as the cryogenic liquid is stored in the storage tank). Embodiments may also permit the filling of the vehicle tanks to occur more quickly and efficiently.

In a first aspect, a cryogenic fluid dispensing apparatus is provided. Embodiments of the apparatus can include a tank positioned and configured to retain a cryogenic liquid. A cryogenic gas is formable in the tank while the tank stores the cryogenic liquid. The tank can be fluidly connected to at least one dispenser feed vessel so that the cryogenic liquid within the tank is feedable to the at least one dispenser feed vessel. The at least one dispenser feed vessel can be fluidly connected to a vapor recovery mechanism and/or a source of gas so that the gas from the source of gas and/or the cryogenic gas of the tank is feedable to the at least one dispenser feed vessel to at least help pressurize the at least one dispenser feed vessel to feed the cryogenic liquid within the at least one dispenser feed vessel to a dispenser feed conduit for feeding to at least one dispenser.

In some embodiments, at least one dispenser can receive the liquid from the dispenser feed vessel(s) to fill a vehicle fuel tank or other tank (e.g. trailer tank, tank for liquid hydrogen transport, transportation tank, etc.) for filling the tank to a pre-selected level. In some embodiments, a portion of the tank filling may be provided via the dispenser feed vessel(s) (e.g. the last 15%-20% of the filing may be provide via the vessel(s), the last 5%-10% of the filling of the tank may be provided via the liquid within the vessel(s), etc.). In other embodiments, an entirety of the tank filling can be provided via liquid retained in the dispenser feed vessel(s).

In a second aspect, the tank can have at least one tube of a heat exchanger arrangement positioned in the tank. The at least one tube can be fluidly connectable to the at least one dispenser feed vessel so that vapor of the at least one dispenser feed vessel is feedable to the at least one tube. In some embodiments, the at least one dispenser feed vessel can be positioned and configured to feed the vapor to the at least one tube during depressurization of the at least one dispenser feed vessel, for example, As another example, the vapor from the dispenser feed vessel(s) can be fed to the at least one tube of the heat exchanger arrangement while liquid is being fed to the dispenser feed vessel(s) and vapor may be formed as a consequence of the liquid being fed into warmer vessel(s).

In a third aspect, the at least one dispenser feed vessel can be positioned and configured to feed vapor from the at least one dispenser feed vessel to the vapor recovery mechanism. For instance, in some embodiments the vapor fed to the vapor recovery mechanism can be utilized to pressurize the dispenser feed vessel(s) at another time or operational cycle so that such vapor can be re-utilized instead of vented or wasted.

In a fourth aspect, the dispenser feed vessel(s) can be positioned and configured to feed vapor from the dispenser feed vessel(s) to the vapor recovery mechanism during depressurization of the at least one dispenser feed vessel.

In a fifth aspect, the tank is connected to the vapor recovery mechanism so that the cryogenic gas within the tank is feedable to the vapor recovery mechanism and the dispenser feed vessel(s) can be fluidly connected to the vapor recovery mechanism so that the cryogenic gas feedable to the vapor recovery mechanism is feedable to the dispenser feed vessel(s) to at least help pressurize the dispenser feed vessel(s) to feed the cryogenic liquid within the dispenser feed vessel(s) to the dispenser feed conduit for feeding to at least one dispenser.

In some embodiments, the vapor recovery mechanism can have a gas outlet conduit positioned to pass a portion of the cryogenic gas to a storage device, a fuel cell, or a gaseous dispenser. In some embodiments, the vapor recovery mechanism can include a buffer tank positioned to receive and retain the cryogenic gas. For instance, the vapor recovery mechanism can include a compressor positioned to compress the cryogenic gas and feed the compressed cryogenic gas to a buffer tank connected to the dispenser feed vessel(s) so that the cryogenic gas is feedable to the at least one dispenser feed vessel.

In a sixth aspect, the cryogenic liquid is liquid hydrogen and the cryogenic gas is hydrogen gas. In other embodiments, the cryogenic liquid can be another type of liquid (e.g. liquid natural gas, etc.) and the cryogenic gas can be another type of gas (e.g. natural gas).

In a seventh aspect, the tank can have at least one tube of a heat exchanger arrangement positioned in the tank. The tube(s) can be fluidly connectable to the dispenser feed vessel(s) so that vapor of the dispenser feed vessel(s) can be feedable to the tube(s). The tube(s) can also be fluidly connectable to the vapor recovery mechanism to feed the vapor from the at least one tube to the vapor recovery mechanism after the vapor has passed through the at least one tube.

In an eighth aspect, the tank can be connected to the vapor recovery mechanism so that the cryogenic gas within the tank is feedable to the vapor recovery mechanism and the dispenser feed vessel(s) can be fluidly connected to the vapor recovery mechanism so that the cryogenic gas feedable to the vapor recovery mechanism is feedable to the dispenser feed vessel(s) to at least help pressurize the at least one dispenser feed vessel(s) to feed the cryogenic liquid within the dispenser feed vessel(s) to the dispenser feed conduit for feeding to at least one dispenser. In some embodiments, the at least one dispenser feed vessel can be fluidly connected to the vapor recovery mechanism so that the cryogenic liquid is feedable to the dispenser feed conduit for feeding to at least one dispenser without use of a pump.

In a ninth aspect, the at least one dispenser feed vessel can include baffles and/or a distributor plate.

In a tenth aspect, the tank can be connected to the vapor recovery mechanism so that the cryogenic gas within the tank is feedable to the vapor recovery mechanism and the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser.

In an eleventh aspect, the apparatus of the first aspect can include one or more features of the second aspect, third aspect, fourth aspect, fifth aspect, sixth aspect, seventh aspect, eighth aspect, ninth aspect and/or tenth aspect. Embodiments can also utilize other features or elements. Examples of such other features or elements can be appreciated from the exemplary embodiments discussed herein, for instance.

In a twelfth aspect, a process for cryogenic fluid dispensing is provided. Embodiments of the process can include feeding vapor from a tank that retains a cryogenic liquid to a vapor recovery mechanism, feeding the cryogenic liquid from the tank to at least one dispenser feed vessel, and after the at least one dispenser feed vessel is sufficiently filled with the cryogenic liquid from the tank, pressurizing the at least one dispenser feed vessel with gas to feed the cryogenic liquid to at least one dispenser for filling a tank of a vehicle with the cryogenic liquid. The gas that is fed to the dispenser feed vessel(s) can include cryogenic gas fed to the vapor recovery mechanism via the tank and/or other gas from at least one other source of gas.

Embodiments of the process can also utilize other steps. Also, embodiments of the apparatus can be configured to implement an embodiment of the process.

In some embodiments, the gas can include hydrogen gas and the cryogenic liquid can be liquid hydrogen. Other embodiments may utilize other types of gas and/or cryogenic liquid.

In a thirteenth aspect, the gas utilized to pressurize the at least one dispenser feed vessel includes the vapor fed to the vapor recovery mechanism.

In a fourteenth aspect, the gas utilized to pressurize the at least one dispenser feed vessel can also include gas from at least one storage device.

In a fifteenth aspect, the process can also include depressurizing the at least one dispenser feed vessel so that fluid from the at least one dispenser feed vessel is feedable to the tank or a heat exchanger arrangement positioned in the tank.

In a sixteenth aspect, the process can also include depressurizing the at least one dispenser feed vessel so that fluid from the at least one dispenser feed vessel is feedable to the vapor recovery mechanism. In some embodiments, the depressurizing of the at least one dispenser feed vessel can also be performed such that the fluid from the at least one dispenser feed vessel is also feedable to the tank or a heat exchanger arrangement positioned in the tank.

In a seventeenth aspect, the process of the twelfth aspect can include one or more features of the thirteenth aspect, fourteenth aspect, fifteenth aspect, and/or sixteenth aspect. Embodiments can also utilize other features or elements. Examples of such other features or elements can be appreciated from the exemplary embodiments discussed herein, for instance.

It should be appreciated that embodiments of the process and apparatus can utilize various conduit arrangements and process control elements. For instance, embodiments may utilize sensors (e.g., pressure sensors, temperature sensors, flow rate sensors, etc.), controllers, valves, and other process control elements. Some embodiments can utilize an automated process control system and/or a distributed control system (DCS). Various different conduit arrangements and process control systems can therefore be utilized to meet a particular set of design criteria for a particular embodiment.

Other details, objects, and advantages of our apparatuses for cryogenic fluid dispensing, processes for cryogenic fluid dispensing, and methods of making and using the same will become apparent as the following description of certain exemplary embodiments thereof proceeds.

### BRIEF DESCRIPTION OF THE DRAWINGS

Exemplary embodiments of apparatuses for cryogenic fluid dispensing, processes for cryogenic fluid dispensing, and methods of making and using the same are shown in the drawings included herewith. It should be understood that like reference characters used in the drawings may identify like components.

FIG. 1 (which can also be referred to as FIG. 1) is a schematic block diagram of a first exemplary embodiment of a cryogenic fluid dispensing apparatus A. Embodiments of our process for cryogenic fluid dispensing can be utilized in this embodiment of the apparatus A.

FIG. 2 (which can also be referred to as FIG. 2) is a schematic block diagram of a second exemplary embodiment of the cryogenic fluid dispensing apparatus. Embodiments of our process for cryogenic fluid dispensing can be utilized in this implementation of our embodiment of the apparatus A.

FIG. 3 (which can also be referred to as FIG. 3) is a schematic block diagram of a third exemplary embodiment of the cryogenic fluid dispensing apparatus A. Embodiments of our process for cryogenic fluid dispensing can be utilized in this implementation of our embodiment of the apparatus A.

FIG. 4 (which can also be referred to as FIG. 4) is a schematic block diagram of a fourth exemplary embodiment of the cryogenic fluid dispensing apparatus A. Embodiments of our process for cryogenic fluid dispensing can be utilized in this implementation of our embodiment of the apparatus A.

FIG. 5 (which can also be referred to as FIG. 5) is a schematic block diagram of a fifth exemplary embodiment of the cryogenic fluid dispensing apparatus A. Embodiments of our process for cryogenic fluid dispensing can be utilized in this implementation of our embodiment of the apparatus A.

FIG. 6 (which can also be referred to as FIG. 6) is a schematic block diagram of a sixth exemplary embodiment of the cryogenic fluid dispensing apparatus A. Embodiments of our process for cryogenic fluid dispensing can be utilized in this implementation of our embodiment of the apparatus A.

FIG. 7 (which can also be referred to as FIG. 7) is a schematic block diagram of a seventh exemplary embodiment of the cryogenic fluid dispensing apparatus A. Embodiments of our process for cryogenic fluid dispensing can be utilized in this implementation of our embodiment of the apparatus A.

FIG. 8 (which can also be referred to as FIG. 8) is a schematic block diagram of an eighth exemplary embodiment of the cryogenic fluid dispensing apparatus A. Embodiments of our process for cryogenic fluid dispensing can be utilized in this implementation of our embodiment of the apparatus A.

FIG. 9 (which can also be referred to as FIG. 9) is a schematic diagram of an exemplary liquid dispenser feed tank assembly that can include multiple dispensing vessels 20.

Embodiments of the exemplary liquid dispenser feed tank assembly can be utilized in the first, second, third, fourth, fifth, sixth, seventh, or eighth exemplary embodiments of the cryogenic fluid dispensing apparatus A shown in FIGS. 1-8 and can also be utilized in exemplary embodiments of our process for cryogenic fluid dispensing.

FIG. 10 (which can also be referred to as FIG. 10) is a block diagram of an exemplary embodiment of the vapor recovery mechanism 6 that can be utilized in embodiments of the cryogenic fluid dispensing apparatus A and can also be utilized in exemplary embodiments of our process for cryogenic fluid dispensing. For instance, embodiments of the exemplary embodiment of the vapor recovery mechanism 6 can be utilized in the first, second, third, fourth, fifth, sixth, seventh, or eighth exemplary embodiments of the cryogenic fluid dispensing apparatus A shown in FIGS. 1-8.

FIG. 11 (which can also be referred to as FIG. 11) is a schematic diagram of an exemplary embodiment of a dispensing vessel 20.

FIG. 12 (which can also be referred to as FIG. 12) is schematic top view of an exemplary embodiment of a baffle 20bf of the dispensing vessel 20 shown in FIG. 11. FIG. 12 illustrates an exemplary arrangement of holes 20bh that can be arranged within baffles 20bf.

FIG. 13 (which can also be referred to as FIG. 13) is a schematic diagram of another exemplary embodiment of a dispensing vessel 20.

FIG. 14 (which can also be referred to as FIG. 14) is a schematic diagram of an exemplary embodiment of a cryogenic fluid dispensing station 31 that can include multiple dispenser stations having one or more dispensers for providing cryogenic fluid to a vehicle fuel tank. One or more of the dispenser stations for dispensing liquid hydrogen 33 shown in FIG. 14 can have an exemplary embodiment of our apparatus A for dispensing a cryogenic fluid. Embodiments of our process for cryogenic fluid dispensing can be utilized in this implementation of our embodiment of the apparatus A as well.

FIG. 15 (which can also be referred to as FIG. 15) is a schematic diagram of an exemplary embodiment of a cryogenic fluid dispensing station 31 that can include multiple dispenser stations having one or more dispensers for providing cryogenic fluid to a vehicle fuel tank. A dispenser station for dispensing liquid hydrogen 33 shown in FIG. 16 can have an exemplary embodiment of our apparatus A for dispensing a cryogenic fluid in which there is a common vapor recovery mechanism 6 that may be utilized to facilitate the feeding of the cryogenic gas to the different dispenser feed vessels 20 for the different dispensing stations. Embodiments of our process for cryogenic fluid dispensing can be utilized in this implementation of our embodiment of the apparatus A as well.

FIG. 16 (which can also be referred to as FIG. 16) is a block diagram of an exemplary embodiment of our process for cryogenic fluid dispensing.

### DETAILED DESCRIPTION OF THE INVENTION

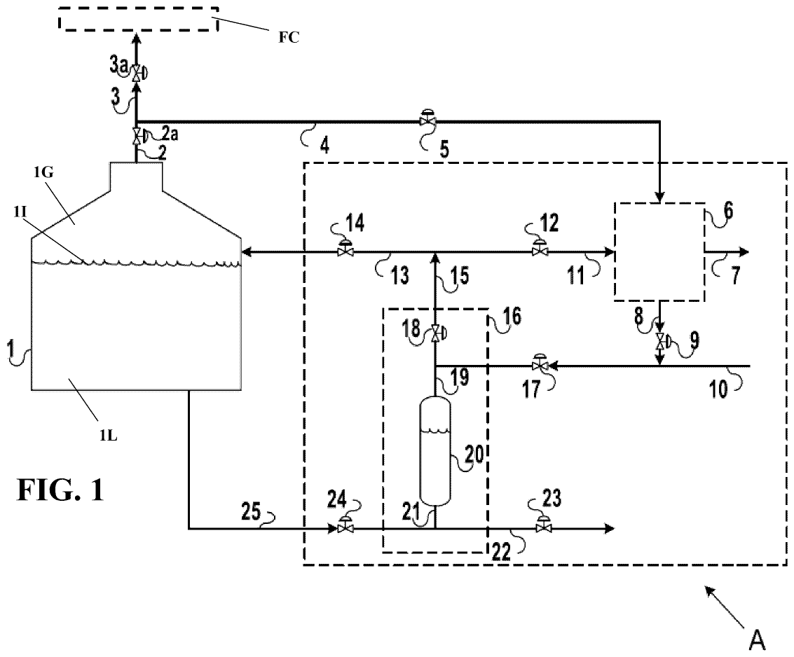

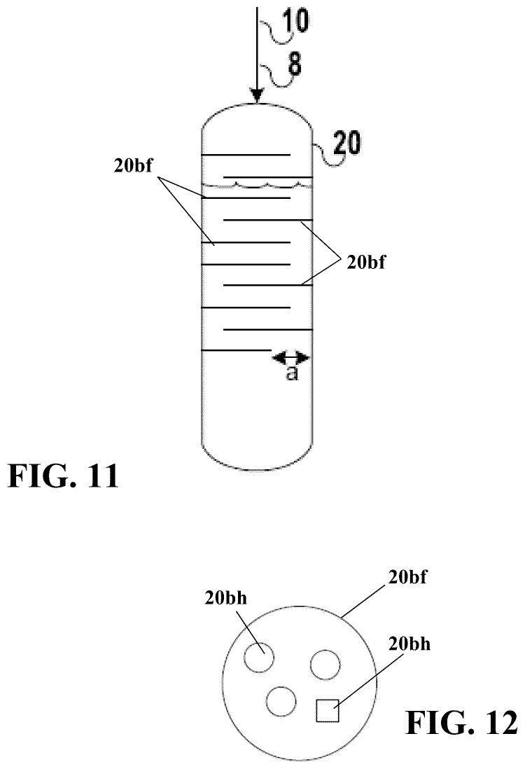

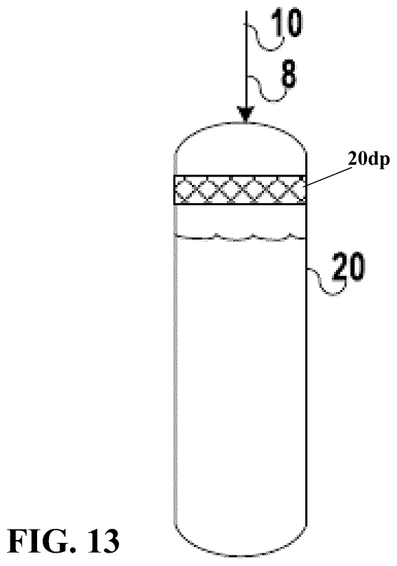

Referring to FIGS. 1-15, an apparatus A for dispensing a cryogenic fluid can include a storage tank 1 that is in fluid communication with a dispenser for feeding a cryogenic fluid that includes liquid to the dispenser. The dispenser can be positioned to receive the cryogenic fluid from the storage tank 1 for feeding to a vehicle fuel tank or vehicle storage tank via a nozzle connected to the dispenser. In some embodiments, the fluid provided to a dispenser can be entirely liquid or can be mostly liquid (e.g. at least 85 volume percent (vol %) liquid, at least 95 vol % liquid, 90 vol % to 100 vol % liquid, etc.). In other embodiments, the fluid that is fed to a dispenser for feeding to a vehicle fuel tank can be entirely liquid.

Embodiments can be configured so that the liquid that is provided to the dispenser may be over its critical pressure, but is also under its critical temperature. For example, some embodiments can be provided so the fluid that is output for feeding to a dispenser for filling a vehicle fuel tank is entirely liquid hydrogen and the liquid hydrogen may be over its critical pressure (e.g. over 1.3 MPa) but also under its critical temperature (e.g. colder than −239.95° C.).

Other embodiments can be configured so that the fluid that is provided to the dispenser may be a cryogenic liquid that is over its critical pressure and also over its critical temperature such that the cryogenic liquid is a super critical fluid. Such a fluid may have both gas-like and liquid-like properties. As used herein, a super critical fluid is considered a cryogenic liquid (e.g. the term cryogenic liquid includes cryogenic liquids and/or cryogenic super critical fluids).

The cryogenic fluid stored within the storage tank 1 can include a liquid 1L. The liquid 1L can be liquid hydrogen, for example. In other embodiments, it is contemplated that the liquid 1L can be liquid natural gas. The tank 1 can also include a gas 1G that has vaporized from the cryogenic liquid 1L as it is stored in the tank 1 or otherwise has been fed to the tank 1. The gas 1G can be a hydrogen gas that is at a cryogenic temperature when the liquid 1L is liquid hydrogen, for example. As another example, the gas 1G can be natural gas that is at a cryogenic temperature when the liquid 1L is liquid natural gas.

The tank 1 can be a stationary horizontally elongated tank, a stationary vertically elongated tank, a mobile tank of a tanker trailer, or other type of vessel for storage of the cryogenic fluid within a chamber of the tank 1 (e.g. can be a horizontal tank or vertical tank, can be a tank of a particular shape, can be a cylindrical shaped tank, can be a polygonal shaped tank, can be a tank of a tanker trailer that may be moved via a truck, etc.). The gas 1G within the tank 1 can be above a top surface of the liquid 1L within the tank 1. The top surface of the liquid within the tank 1 can define a gas/liquid interface 1I within the tank. The gas 1G can be above the interface 1I and the liquid 1L can fill the tank from this interface 1I to a bottom of the chamber of the tank 1.

The storage tank 1 can be configured to maintain the fluid stored in the chamber of the tank 1 to a pre-selected storage temperature and pre-selected storage pressure. The pre-selected storage temperature can be a sub-cooled temperature for maintaining the fluid as a liquid to minimize boil off, or boil up, that may occur as the liquid 1L is stored in the tank 1. For example, when the liquid 1L is liquid hydrogen, the pre-selected storage temperature can be 30 Kelvin (K), which is −243.15° C., or can be in a range of 20K to 40K (e.g., in a range of between −253° C. C and −232° C.). The pre-selected storage pressure of the tank 1 can be between 1 bar to 13 bar (e.g. between 0.1 MPa and 1.3 MPa).

The apparatus A can also include a vapor recovery mechanism 6 that is fluidly connected to the storage tank 1 for receipt of gas from the tank 1 for feeding that gas back to the tank 1 and/or to at least one dispenser feed vessel 20 of a liquid dispenser feed assembly 16 positioned and configured to receive liquid from the tank 1 for feeding the liquid to one or more dispensers for filling of vehicle fuel tanks. The dispenser feed vessel(s) 20 of the liquid dispenser feed assembly 16 can all be positioned within a housing. The housing can be insulated in some embodiments.

As may be appreciated from FIGS. 1-8, the storage tank 1 can be connected to a gas output conduit 2 having a gas output valve 2a that can be adjusted between open and closed positions. The gas output conduit 2 can be connected to a gas delivery conduit 3 that can feed the gas to atmosphere for venting or feed the gas to a fuel cell FC. The gas delivery conduit 3 can include an adjustable valve 3a that can be adjusted between an open position and a closed position so that the gas may be fed to the fuel cell FC or vented when the valve 3a of the gas delivery conduit 3 is opened and can be prevented from being vented or fed to the fuel cell FC when the valve 3a is closed.

In some embodiments, the fuel cell FC can be a hydrogen fuel cell FC that can receive the hydrogen gas when the gas 1G is hydrogen gas and utilize the hydrogen gas to generate electricity for powering operation of the apparatus A and/or fueling station of the apparatus A. In other embodiments, no fuel cell FC may be utilized and if gas is passed through the gas delivery conduit 3, the gas can be vented or fed to a gas storage vessel for subsequent storage, use, and/or transport of the gas. Avoiding venting of the gas 1G can be beneficial as it can allow the gas to be utilized in other processes or in other applications instead of losing the gas to atmosphere.

The gas output conduit 2 of the storage tank 1 can be connected to a vapor recovery mechanism 6 via a first vapor recovery conduit 4 that can be connected between the storage tank 1 and the vapor recovery mechanism 6 (e.g. the vapor recovery conduit 4 can be connected between the gas output conduit 2 and the vapor recovery mechanism 6. The first vapor recovery conduit 4 can have a valve 5 that can be adjusted between an open position and a closed position. The valve 5 of the vapor recovery conduit can be closed to prevent vapor from being fed to the vapor recovery mechanism 6 (e.g. when venting or feeding of gas to the fuel cell FC may be desired, etc.). The valve 5 of the first vapor recovery conduit 4 can also be in an open position while the valve 3a of the gas delivery conduit 3 is closed to facilitate a flow of the gas from the storage tank 1 to the vapor recovery mechanism 6.

In yet other operational conditions, both the valve 3a of the gas delivery conduit 3 and the valve 5 of the first vapor recovery conduit 4 can be opened so some gas is feedable to the fuel cell or for venting while another portion of the gas can be fed to the vapor recovery mechanism 6. How the gas may be routed from the storage tank 1 can depend on demand at the dispenser(s) to which the apparatus A is connected, the extent to which the gas 1G has formed in the tank, the pressure within the storage tank 1, and other operational conditions.

The vapor recovery mechanism 6 can include a vapor storage tank for storage of vapor for subsequent use in feeding liquid to at least one dispenser. The vapor recovery mechanism can also include a gas outlet conduit 7 for directing some vapor to a dispenser that may be configured to dispense gas (e.g. a hydrogen gas dispenser) or to a downstream unit that may utilize the gas (e.g. a fuel cell FC, etc.), a downstream compressor for passing the vapor passed through the gas outlet conduit 7 can be fed to a storage tank or to a pipeline. In yet another alternative, the vapor passed through the gas outlet conduit 7 can be fed to a hydrogen gas storage unit (e.g. trailer(s), storage tank(s), etc.) for subsequent use (e.g. for supplying hydrogen gas to the vapor feed conduit 10).

At least some of the vapor that is fed to the vapor recovery mechanism 6 can be utilized to facilitate the feeding of the liquid 1L from the storage tank 1 to a dispenser. For example, the storage tank 1 can be connected to at least one dispenser feed vessel 20 to feed cryogenic liquid 1L (e.g. liquid hydrogen) to the dispenser feed vessel(s) 20 via a dispenser feed vessel feed conduit 25 that is connected between the tank 1 and the dispenser feed vessel(s) 20. The dispenser feed vessel conduit 25 can include a valve 24 that can be adjusted between closed and open positions to control the flow of liquid 1L to the dispenser feed vessel(s). The valve 24 of the dispenser feed vessel feed conduit 25 can be opened to feed liquid 1L to the dispenser feed vessel(s) 20 and can be closed after the dispenser feed vessel(s) received a sufficient amount of liquid 1L for fueling operations or can be otherwise closed to stop feeding of liquid 1L to the dispenser feed vessel(s) 20.

In some embodiments, a dispenser feed vessel liquid conduit 21 can be connected between the dispenser feed vessel(s) 20 and the dispenser feed vessel feed conduit 25 so that liquid can be fed into the dispenser feed vessel(s) 20 during a filling stage of operation for a fueling operation. The dispenser feed vessel liquid conduit 21 can include at least one valve that can be adjusted between closed and open positions so fluid from the dispenser feed vessel(s) 20 can be adjustably fed to a dispenser feed conduit 22 and/or the dispenser feed vessel feed conduit 25. For example, the dispenser feed vessel liquid conduit 21 can also be connected between the dispenser feed vessel(s) 20 and the dispenser feed conduit 22 so the liquid from within the dispenser feed vessel(s) 20 can be output (or selectively output via use of at least one valve of the dispenser feed vessel liquid conduit) from the vessel(s) during another stage of the fueling operation after the vessel(s) 20 are filled with liquid as well.

For example, after each dispenser feed vessel 20 is sufficiently filled, the valve 24 can be closed and vapor from the vapor recovery mechanism 6 can be output to the dispenser feed vessel 20 to pressurize the vessel and drive a flow of the liquid 1L towards at least one dispenser. For example, a vapor recovery mechanism output conduit 8 can be fluidly connected to the dispenser feed vessel(s) 20 for feeding vapor to an upper portion of each dispenser feed vessel 20 to pressurize the vessel and drive a flow of liquid 1L out of the vessel and toward at least one dispenser via the dispenser feed vessel liquid conduit 21 that can be connected between the dispenser feed vessel(s) 20 and a dispenser feed conduit 22 so that the dispenser feed conduit 22 can be fluidly connected to the dispenser feed vessel 20.

In some embodiments, such feeding of liquid via the dispenser feed vessel 20 can occur after a fuel tank or other type of vehicle tank has been filled to a pre-selected initial filling capacity via use of liquid output from the tank 1. For example, the feeding of liquid from the dispenser feed conduit 20 can be actuated after the vehicle tank is entirely empty, mostly empty, or is at another pre-selected filled condition (e.g. between 0% and less than 100% full, between 70% and less than 100% filled, between 80% and 95% filled, etc.) to provide a remaining liquid for feeding to the tank to complete the filling of the tank. A valve of the dispenser feed vessel liquid conduit 21 can be adjusted between closed and open positions to help facilitate such feeding of the liquid of the dispenser feed vessel(s) 20 after the valve 24 is closed and vapor from the vapor recovery mechanism 6 can be output to the dispenser feed vessel 20 to pressurize the vessel and drive a flow of the liquid 1L towards at least one dispenser. The vapor that can be fed to the dispenser feed vessel to pressurize the vessel 20 can be cold (e.g. cryogenic) or may be at an ambient temperature.

The feeding of vapor can be initiated via opening of a valve 9 of the vapor recovery mechanism output conduit 8 so that vapor from the vapor recovery mechanism 6 can be fed to the upper portion of the dispenser feed vessel(s) 20 to pressurize the vessel(s) to a pre-selected dispenser feed pressure for feeding the liquid within the vessel to at least one dispenser that is fluidly connected to the vessel(s) 20.

The vapor output from the vapor recovery mechanism 6 can be fed to at least one dispenser feed vessel vapor conduit 19 that can be fluidly connected between the vapor recovery mechanism 6 and the dispenser feed vessel(s) 20. The vapor that is fed to the dispenser feed vessel 20 can also include other vapor that can be passed to the dispenser feed vessel(s) 20 via a vapor feed conduit 10. When the liquid 1L is hydrogen, the vapor feed conduit 10 can receive hydrogen gas from hydrogen gas storage (e.g. a storage vessel, a hydrogen pipeline, a hydrogen gas dispensing station that has hydrogen gas and is no longer using that gas for dispensing operations, etc.). In embodiments where the liquid 1L is another type of fluid, the vapor that is utilized may be of that same type (e.g. natural gas when the liquid is liquid natural gas, etc.).

In some embodiments, the vapor recovery mechanism output conduit 8 can be connected to the vapor feed conduit 10 so that a valve 17 of the vapor feed conduit 10 can be opened for feeding the vapor to the dispenser feed vessel(s) 20 to sufficiently pressurize the vessel(s) for dispensing operations. Gas from the vapor feed conduit 10 can also include gas from a source of gas that may be utilized in place of gas from the vapor recovery mechanism output conduit 8 or to provide additional supplemental gas to sufficiently pressurize dispenser feed vessel 20 to pressurize the vessel and drive a flow of the liquid 1L towards at least one dispenser. This gas that may be utilized for dispenser feed vessel 20 pressurization can be cryogenic in temperature, may be cold, or may be at another suitable temperature (e.g. ambient temperature, etc.).

The dispenser can receive the liquid from the dispenser feed conduit 22 and feed that liquid to a vehicle fuel tank via a nozzle of the dispenser that can be connectable with the vehicle fuel tank. The dispenser feed conduit 22 can include a valve 23 that can be closed when liquid 1L is being fed to the dispenser feed vessel(s) 20. The valve 23 can be opened when the valve 24 of the dispenser feed vessel conduit 25 is closed and the vapor is being fed to the dispenser feed vessel(s) 20 to pressurize the vessel for driving the liquid through the dispenser feed conduit 22. In some embodiments, the opening of the valve 23 can occur in response to the pressure of the dispenser feed vessel(s) being at or above a pre-selected pressure for feeding the liquid to the dispenser.

After the vessel(s) 20 are sufficiently emptied or the dispensing operation is complete (e.g. a vehicle tank is full or an operator has stopped filling the vehicle fuel tank and dispensing of the liquid is completed, etc.), the valve 23 of the dispenser feed conduit 22 can be closed and the valve 24 can be kept closed as well.

After the valve 23 is closed, valve 17 and/or valve 9 may also be closed so that the fluid from within the dispenser feed vessel(s) 20 can be passed out of the vessel(s). For example, a valve 18 of the dispenser feed vessel vapor conduit 19 can be adjusted from a closed position to an open position to depressurize the vessel(s) 20 and help drive a flow of the fluid out of the dispenser feed vessel 20 and to the storage tank 1 and/or the vapor recovery mechanism 6 for recovery and/or use of the fluid. This fluid can be mostly vapor or entirely vapor and can be very cold (e.g. be vaporized liquid that is at a very cold, cryogenic temperature or near such a temperature, etc.). Any remaining liquid from within each dispenser feed vessel 20 may vaporize as it warms and/or be vaporized via the opening of the valve 18 and the reduction in pressure of the vessel 20 that may occur and that vapor can be passed out of the dispenser feed vessel(s) for feeding to the tank 1 and/or the vapor recovery mechanism 6 for subsequent use.

Also, any vapor that may remain in each dispenser feed vessel 20 can be pushed out of the vessel when liquid is fed into the vessel for a next fueling operation. The liquid can displace the vapor and the vapor can be passed from the vessel(s) 20 to return to the tank 1 for subsequent use or for being fed to the vapor recovery mechanism 6 for subsequent use.

The cold vapor that may be formed during the dispenser feed vessel depressurization can be fed to the tank 1 to help utilize that cold fluid to help maintain the cold temperature and or pressure of fluid in the tank 1 or can be fed to the vapor recovery mechanism 6 to provide a source of cold vapor to help with storage and subsequent use of the vapor for a subsequent pressurization of the dispenser feed vessel(s) 20 for a subsequent fueling operation.

For example, a stream of cold vapor 15 can be passed out of the open valve 18 during depressurization of the dispenser feed vessel(s) 20 and fed to the tank via opening of a valve 14 of a tank return conduit 13 that can be connected between the dispenser feed vessel vapor conduit 19 and the tank 1. Alternatively, valve 14 can be kept closed and a valve 12 of a second vapor recovery conduit 11 can be opened for feeding of the vapor output from the dispenser feed vessel(s) 20 to the vapor recovery mechanism 6. The second vapor recovery conduit 11 can be connected between the dispenser feed vessel vapor conduit 19 and the vapor recovery mechanism 6 for providing a more direct pathway for the flow of vapor to the vapor recovery mechanism 6. This can be provided in addition to the tank return conduit 13 in some embodiments. Other embodiments may only utilize the tank return conduit 13.

Vapor passed to the tank 1 via the tank return conduit 13 can be utilized as a refrigerant to help maintain a colder temperature of the tank 1. The gas therein can also be utilized via opening of valve 2a for feeding gas to the fuel cell FC or to the first vapor recovery conduit 4 for being fed to the vapor recovery mechanism 6. The gas may alternatively be output from the tank 1 for being fed to the first vapor recovery conduit 4 via another conduit that can be connected between the tank 1 and the first vapor recovery conduit 4. Such outputting of the gas can occur as part of a pressure reduction within the tank to help maintain a pressure of the tank in some embodiments.

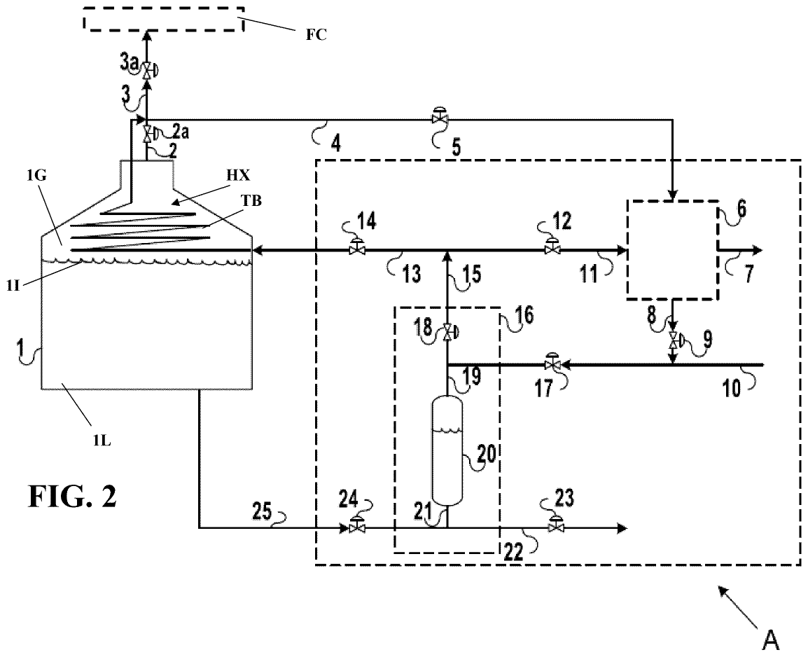

As may be appreciated from FIGS. 2, 3, 4, and 5, the vapor passed to the tank 1 via the tank return conduit 13 can be connected to a heat exchanger conduit arrangement HX positioned in an upper portion of the tank 1. The cold vapor can be passed through the heat exchanger conduit arrangement HX for providing heat exchange with the liquid 1L and/or gas 1G in the tank 1 to cool that fluid before being output from the tank 1 and being fed to the first vapor recovery conduit 4 via a heat exchanger outlet conduit that can be connected between the first vapor recovery conduit 4 and the heat exchanger conduit arrangement HX.

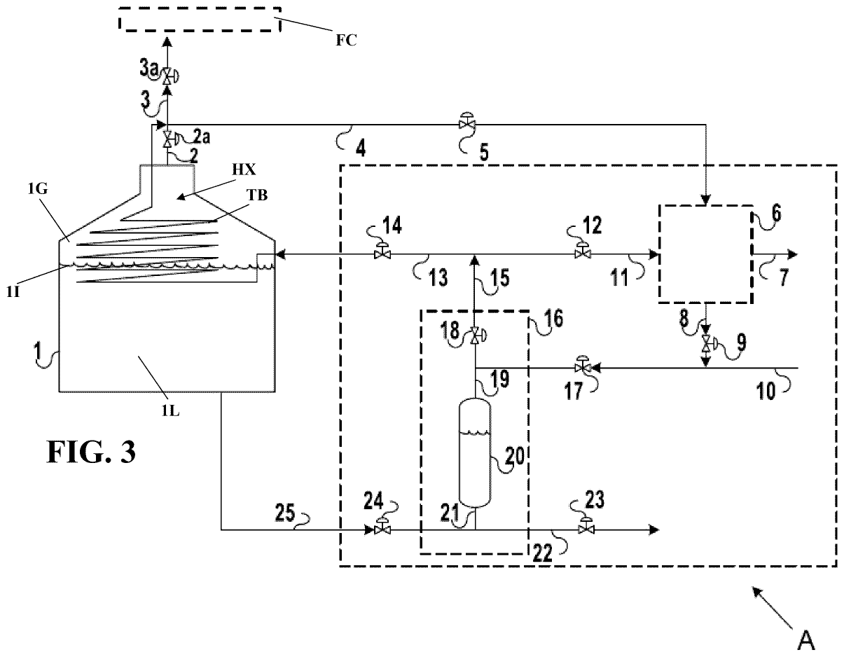

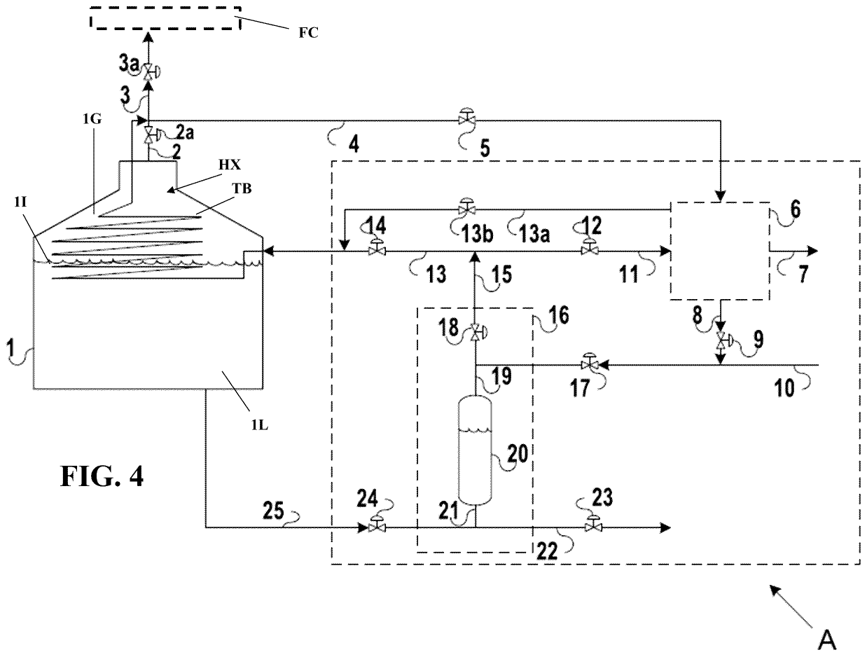

For example, in the embodiment shown in FIG. 2, the entirety of the heat exchanger conduit arrangement positioned in the upper portion of the tank 1 can be located above the interface 1I so that the vapor is utilized to control a temperature of the gas 1G in the tank 1. As another example, the heat exchanger arrangement HX within the tank 1 can include tubing for the vapor that is positioned below the interface 1I so that a portion of the tubing is located in the liquid 1L and the remaining portion is located above the interface 1I for cooling of the gas 1G as the vapor is passed through the heat exchanger arrangement HX of the tank 1 as shown in FIGS. 3 and 4.

In some embodiments, some vapor output from the vapor recovery mechanism 6 can be fed to the tank 1 for being utilized as a refrigerant for temperature control of the fluid in the tank 1 via a tank feed conduit 13a positioned between the vapor recovery mechanism 6 and the tank feed conduit 13 (see e.g. FIG. 4). For example, the tank feed conduit 13a can be positioned between the vapor recovery mechanism and the heat exchanger arrangement HX for feeding cold vapor to at least one tube TB of the heat exchanger arrangement HX positioned in the tank 1 to be passed through the tube(s) TB to exchange heat with fluid in the tank 1 prior to being output from the tank 1 for being directed to the first vapor recovery conduit 4 or the gas delivery conduit 3 (e.g. for feeding to a fuel cell FC, venting, or other use). As another example, the tank feed conduit 13a can be positioned between the vapor recovery mechanism and the upper portion of the tank 1 (e.g. a head space portion of the tank 1 that may be above a liquid upper level of the tank) to feed vapor to the head space of the tank 1 to help pressurize the tank 1 for feeding liquid 1L from the tank toward a dispenser.

The tank feed conduit 13a can include a valve 13b that can be adjustable between open and closed positions so that the feeding of vapor from the vapor recovery mechanism 6 to the heat exchanger arrangement tubing of the tank 1 can be selectively provided. The valve 13b can be closed to prevent feeding of such vapor and can be opened to selectively facilitate the feeding of vapor to the tank 1 or the heat exchanger arrangement HX of the tank 1.

Some embodiments can be configured to facilitate cooling of the dispenser feed conduit 22 to pre-cool the dispenser feed conduit 22 before a cryogenic liquid is passed through the dispenser feed conduit 22. This type of pre-cooling can help limit the vaporization of liquid that may occur as the conduit is cooled via the passing of the cryogenic liquid through the dispenser feed conduit 22. The cooling can be provided via cryogenic gas that can be fed directly to the dispenser feed conduit 22 via a pre-cooling conduit 19y that can be positioned so that cryogenic gas from one or more dispenser feed vessels 20 can be fed to the dispenser feed conduit directly for pre-cooling the conduit. Alternatively, the cryogenic gas passed to the dispenser feed conduit 22 can be from the vapor recovery mechanism 6 or other source of cryogenic gas that may be routed for pre-cooling via the pre-cooling conduit 19y instead of being passed to one or more of the dispenser feed vessels 20 to pressurize the vessel(s). In yet other arrangements, the cryogenic gas can be fed to a dispenser feed heat exchanger 19z for cooling of the dispenser feed conduit 22 via use of the cryogenic gas. The pre-dispenser cooling can be provided downstream of the dispenser feed vessel(s) 20 and upstream of the dispenser(s) to which the liquid is being fed.

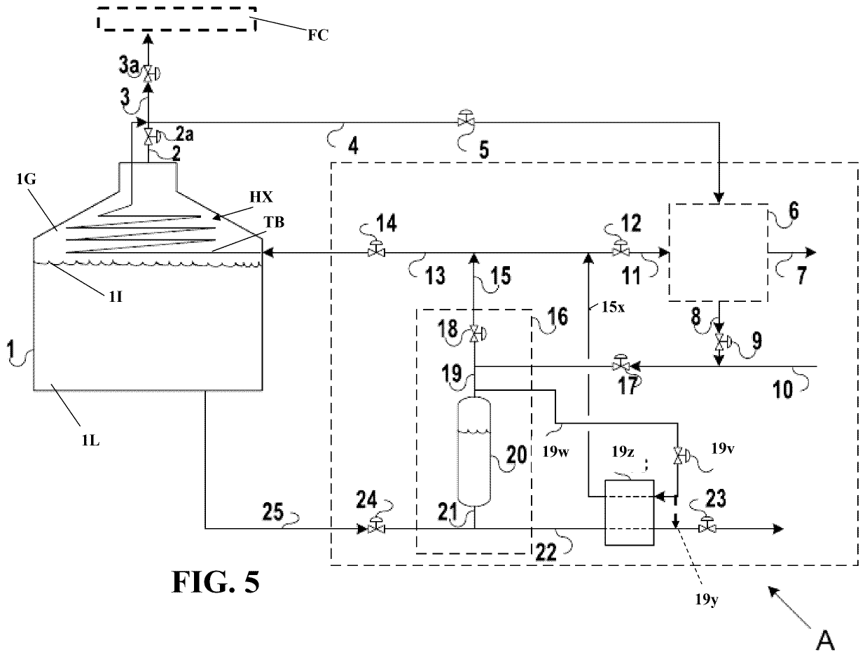

For example, FIG. 5 illustrates an example of such an embodiment in which the cooling of the dispenser feed conduit 22 can be provided via a dispenser feed heat exchanger 19z or the pre-cooling conduit 19y. In some embodiments that utilize the dispenser feed heat exchanger 19z, the heat exchanger can be positioned between the dispenser feed vessel(s) 20 and the dispenser for providing heat exchange between gas that can be provided via the vapor feed conduit 10 and the dispenser feed conduit 22. For example, a dispenser feed heat exchanger feed conduit 19w can be positioned between the dispenser heat exchanger 19z and the dispenser feed vessel vapor conduit 19 so that some of the gas being passed to the dispenser feed vessel(s) 20 for pressurizing the vessel(s) can be split so a portion of this gas can be fed to the dispenser feed heat exchanger 19z for cooling the dispenser feed conduit 22 to provide a desired temperature control function for controlling the heat of the liquid being supplied to the dispenser. The dispenser feed heat exchanger feed conduit 19w can include a control valve 19v for controlling a flow of gas fed to the dispenser feed heat exchanger 19z.

In some other embodiments that may utilize multiple different dispenser feed vessels 20, the dispenser feed heat exchanger feed conduit 19w can be positioned between the dispenser heat exchanger 19z and at least one of the dispenser feed vessels 20 so that vapor from at least one dispenser feed vessel 20 can be output from that vessel and fed to the dispenser feed heat exchanger 19z. For example, the dispenser feed heat exchanger feed conduit 19w can be connected to a vapor conduit 19 so that gas can be passed out of one or more dispenser feed vessels 20 so at least a portion of this gas can be fed to the dispenser feed heat exchanger 19z for cooling of the dispenser feed conduit 22 to provide a desired temperature control function for the dispenser feed conduit 22 for controlling the heat of the liquid being supplied to the dispenser. The dispenser feed heat exchanger feed conduit 19w can include a control valve 19v for controlling a flow of gas fed to the dispenser feed heat exchanger 19z.

The gas output from the dispenser feed heat exchanger 19z to function as a heat exchange medium with the dispenser feed conduit 22 can be fed to a dispenser feed heat exchanger output conduit 15x that can be positioned to feed the gas output from the dispenser feed heat exchanger 19z to the tank return conduit 13 for passing that fluid to the tank 1 or heat exchanger arrangement HX in the tank 1. The gas output from the dispenser feed heat exchanger 19z can alternatively be fed to the second vapor recovery conduit 11 for being fed to the vapor recovery mechanism 6 dispenser feed heat exchanger output conduit 15x. In such an embodiment, the dispenser feed heat exchanger output conduit 15x can be positioned between the dispenser feed heat exchanger 19z and the second vapor recovery conduit 11. In some embodiments, the dispenser feed heat exchanger output conduit 15x can be positioned and connected to both the second vapor recovery conduit 11 and the tank return conduit 13 so that the option of feeding the gas output from the feed dispenser heat exchange 19z can be passed toward the tank 1 and/or toward the vapor recovery mechanism 6 based on positioning of valves 12 and 14.

The dispenser feed heat exchanger 19z can be positioned to use gas that can be fed to the dispenser feed heat exchanger 19z as a cooling medium (e.g. gas from at least one dispenser feed vessel 20, gas from the vapor recovery mechanism 6, gas from the tank 1 that may be fed to the vapor recovery mechanism 6 before being fed to the dispenser feed heat exchanger 19z, gas from the vapor feed conduit 10, etc.) to cool the dispenser feed conduit 22 so that this conduit can be pre-cooled prior to liquid being passed through the dispenser feed conduit 22. Which source of or sources of gas that may be used for the pre-cooling can be based on a desired level of cooling and the temperature of the gas from the different sources of gas. Such pre-cooling can help limit liquid vaporization that may occur from cryogenic liquid being passed through a conduit at an ambient temperature or a temperature that is warmer than the cryogenic liquid.

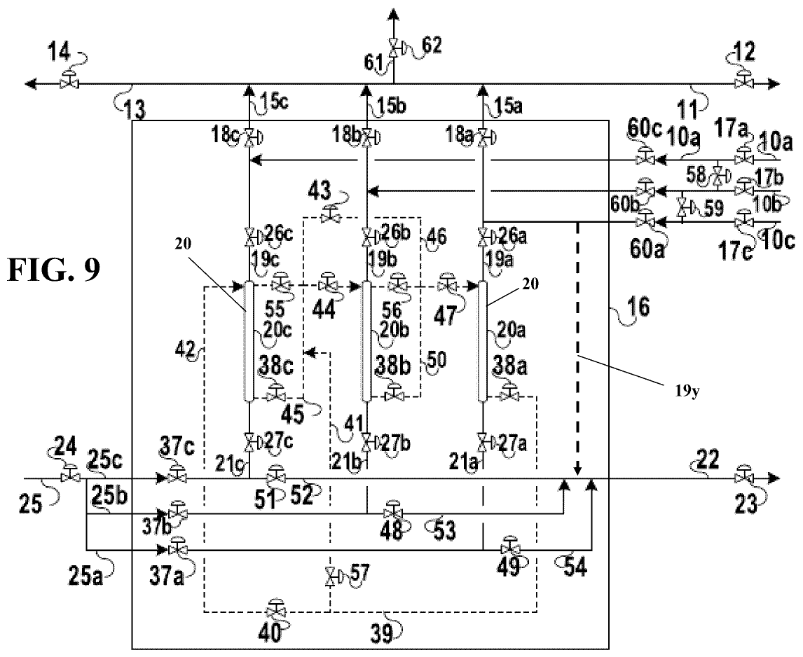

In yet other embodiments (as shown in broken line in FIGS. 5 and 9), the pre-cooling conduit 19y can be positioned so that cryogenic gas retained within at least one of the dispenser feed vessels 20 can be fed directly to the dispenser feed conduit 22 to pass through the dispenser feed conduit 22 to precool the conduit to help minimize the amount of cryogenic liquid that may vaporize as it is subsequently passed through the dispenser feed conduit 22 for being fed to a dispenser. The cryogenic gas can be provided by one or more dispenser feed vessels 20 via adjustment of valves that can be positioned to control a flow of the cryogenic gas from the dispenser feed vessel(s) 20 to the dispenser feed conduit 22. For instance, cryogenic gas can be output from a dispenser feed vessel 20 via the dispenser feed vessel vapor conduit 19 and passed to the pre-cooling conduit 19y via a connection the pre-cooling conduit 19y can have with the dispenser feed vessel vapor conduit 19. The cryogenic gas utilized for this pre-cooling can pass through the dispenser feed conduit to cool that conduit and be subsequently vented or routed to the vapor recovery mechanism 6, for example.

As another example, as may best be seen from FIG. 9, at least one of the dispenser feed vessels 20 can output cryogenic gas for being fed to the pre-cooling conduit 19y via an adjustment of valves (e.g. adjustment of valve 26a to an open position, closing of valve 60a, and opening of a valve of pre-cooling conduit 19y). This pre-cooling feed of cryogenic gas can be provided to the pre-cooling conduit 19y while other dispenser feed vessels 20 receive cryogenic gas to pressurize the vessel(s). For example, the second and third dispenser feed vessels 19b and 19c can receive cryogenic gas for pressurization of those vessels while the first dispenser feed vessel 20a outputs cryogenic gas for pre-cooling of the dispenser feed conduit 22 via the pre-cooling conduit 19y. After the pre-cooling is completed, valves may be adjusted in position so that cryogenic gas can be fed to the first dispenser feed vessel 20a to pressurize that vessel as well (e.g. valve 26a can be opened and valve 60a can be opened while a valve of the pre-cooling conduit can be closed).

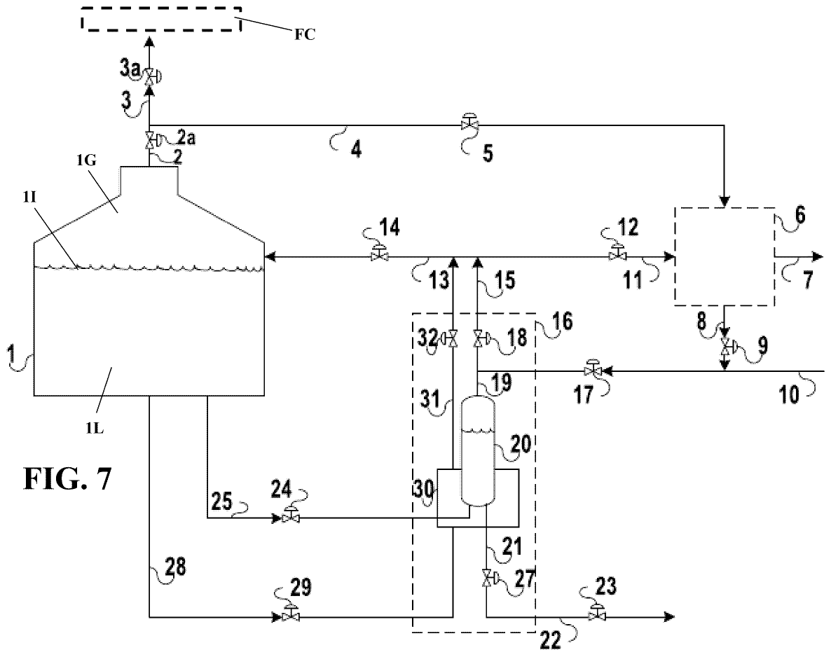

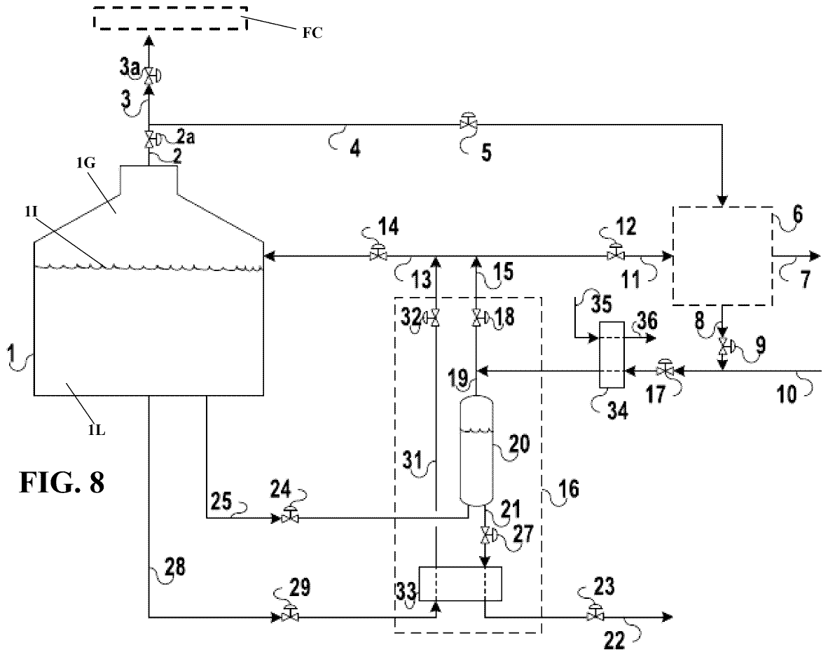

FIGS. 7 and 8 illustrate other examples of providing heat exchange arrangements that can help provide improved temperature control for the liquid that may be output from the dispenser feed vessel(s) 20. FIGS. 7 and 8 illustrate arrangements in which some of the liquid 1L of the tank 1 can be provided for helping to control the temperature of the liquid being output from the dispenser feed vessel(s) 20 for being fed to the dispenser(s) via the dispenser feed conduit 22.

Referring to FIG. 7, a liquid storage tub 30 can be positioned such that a lower portion of one or more dispenser feed vessels 20 can be positioned in the chamber of the tub while liquid from the tank 1 is retained in the tub to surround the outer periphery of each vessel 20 positioned in the tub 30. The dispenser feed vessel liquid conduit 21 can also be at least partially positioned in the tub 30 so that liquid is positioned around an outer periphery of the conduit as well in some embodiments. A tub feed conduit 28 can be positioned between a lower portion of the tank 1 and the tub 30 to feed liquid 1L from the tank 1 to the tub 30. A tub outlet conduit 31 can be positioned to extend from the tub 30 to the tank return conduit 13 and/or the second vapor recovery conduit 11 so that the fluid outputtable from the tub 30 can be fed to the vapor recovery mechanism 6 or the tank 1. In some embodiments, the tub 30 can be an annular shaped vessel that is enclosed to surround the lower portion of the dispenser feed vessel(s) so liquid 1L can contact the vessel and help maintain the temperature of the liquid in the vessel(s) 20 to provide improved temperature control for the liquid output from the vessel(s) while gas is being fed to the vessel(s) to pressurize the vessels for driving the liquid to and through the dispenser feed conduit 22.

The tub feed conduit 28 and the tub output conduit 31 can each include a valve that is adjustable from a closed position to an open position to control the flow of fluid to and from the tub 30. For example, the valve 29 of the tub feed conduit can be adjustable between open and closed positions and the valve 32 of the tub output conduit 31 can be adjustable between open and closed positions to control a flow of fluid fed to the tub and output from the tub to provide a desired level of liquid within the tub to facilitate improved temperature control for the liquid being output from the vessel(s) 20.

Referring to FIG. 8, a dispenser feed cooler 33 can be positioned between the dispenser feed vessel liquid conduit 21 and the dispenser feed conduit 22 to facilitate cooling of the liquid output from the dispenser feed vessel(s) 20 for feeding the liquid to the dispensers at a desired temperature (e.g. a temperature below the critical temperature of hydrogen when the liquid is liquid hydrogen). A cooler feed conduit 28 can be positioned between the cooler 33 and the tank 1 so that liquid from the tank 1 can be fed to the cooler to function as a refrigerant to help cool the liquid being passed from the dispenser feed vessel(s) 20 to the dispenser(s). The liquid that has functioned as the refrigerant can be output from the cooler 33 as fluid for being passed through the cooler output conduit 31 connected to the cooler for routing the fluid from the cooler 33 to the tank return conduit 13 and/or the second vapor recovery conduit 11.

In some configurations, the dispenser feed cooler can be a heat exchanger that may be structured similar to a liquid retention vessel (e.g. a tub or a bath, etc.) in which liquid cryogenic fluid (e.g. liquid hydrogen) can be retained in a chamber of the vessel to provide cooling and the dispenser feed vessel liquid conduit 21 can be positioned to extend through the chamber for contact with the liquid so that the conduit is cooled via the liquid within the chamber of the liquid retention vessel. For example, the dispenser feed vessel liquid conduit 21 can go through the vessel so that the outer layer or outer wall of the dispenser feed vessel liquid conduit 21 contacts the cryogenic liquid (e.g. liquid hydrogen) therein and is cooled via that contact for keeping the liquid being passed out of the dispenser feed vessel 20 cool while it is passed through the dispenser feed vessel liquid conduit 21 for being fed to at least one dispenser.

In some embodiments, the dispenser feed vessel liquid conduit 21 can include a valve 27 that is between the dispenser feed vessel(s) 20 and the cooler 33 to help control a flow of liquid passed through the cooler 33 for being fed to the dispenser(s).

In some embodiments, the gas being provided to the dispenser feed vessel(s) 20 can be pre-cooled before that gas is fed to the vessel(s) to pressurize the vessel(s) 20. Such pre-cooling can help limit the heating of the liquid within the vessel(s) being pressurized and can help limit the amount of vapor that may be formed from the gas being fed to pressurize the vessel(s) 20. A gas pre-cooler 34 can be positioned to receive a flow of refrigerant from a source of refrigerant via a refrigerant feed conduit 35 connected between the gas pre-cooler 34 and the source of the refrigerant.

The refrigerant may be, for example, liquid nitrogen obtained from an air separation unit (ASU) of a facility or may be from another source of refrigerant. The warmed refrigerant can be output from the gas pre-cooler 34 via a refrigerant output conduit 36 connected to the gas pre-cooler for being vented or for other use.

The gas pre-cooler 34 can be a heat exchanger that can be positioned between the vapor recovery mechanism 6 and the dispenser feed vessel(s) 20 for cooling the gas fed toward the dispenser feed vessel(s) 20 before the gas is fed into the vessel(s) 20. The gas pre-cooler 34 can be positioned so that the gas passed through the vapor feed conduit 10 is passed through the pre-cooler 34 prior to being fed into the dispenser feed vessel(s) 20 as well.

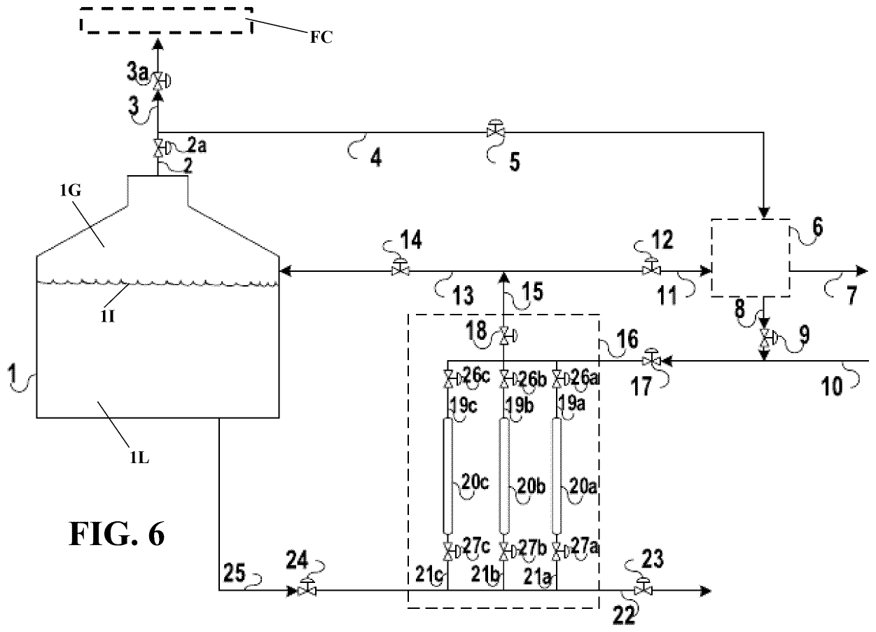

FIGS. 1-5 and 7-8 illustrate a single dispenser feed vessel 20. This single dispenser feed vessel 20 can represent a single vessel or multiple vessels arranged to operate in parallel to provide more control on the dispensing of liquid to a dispenser. FIG. 6 illustrates an exemplary embodiment shown to include multiple dispenser feed vessels 20.

As may best be appreciated from FIG. 6, the dispenser feed vessel(s) 20 can include a first dispenser feed vessel 20a, a second dispenser feed vessel 20b, and a third dispenser feed vessel 20c. Other embodiments can utilize more than three dispenser feed vessels. Yet other embodiments may utilize only one or only two dispenser feed vessels. The number of the vessels that may be utilized and their selected volumetric capacity and/or size can be selected to account for a particular set of design criteria and also account for the size and capacity of a particular dispensing station to be supported by that particular embodiment of the apparatus A.

The dispenser feed vessels 20 can be arranged in parallel so that the liquid 1L fed to the dispenser feed vessels 20 via the dispenser feed vessel feed conduit 25 can be fed to each respective dispenser feed vessel 20 via respective dispenser feed vessel liquid conduits. For example, the first dispenser feed vessel 20a can receive liquid from the dispenser feed vessel feed conduit 25 via a first dispenser feed vessel liquid conduit 21a that is connected between the first dispenser feed vessel 20a and the dispenser feed vessel feed conduit 25. The second dispenser feed vessel 20b can receive liquid from the dispenser feed vessel feed conduit 25 via a second dispenser feed vessel liquid conduit 21b that is connected between the second dispenser feed vessel 20b and the dispenser feed vessel feed conduit 25. The third dispenser feed vessel 20c can receive liquid from the dispenser feed vessel feed conduit 25 via a third dispenser feed vessel liquid conduit 21c that is connected between the third dispenser feed vessel 20c and the dispenser feed vessel feed conduit 25. The first dispenser feed vessel liquid conduit 21a can include a control valve 27a that can be adjustable between open and closed positions, the second dispenser feed vessel liquid conduit 21b can include a control valve 27b that can be adjustable between open and closed positions, and the third dispenser feed vessel liquid conduit 21c can include a control valve 27c that can be adjustable between open and closed positions to facilitate the flow of liquid into the and out of the dispenser feed vessels 20.

Each of the dispenser feed vessels 20 can also receive gas from the vapor recovery mechanism 6 and/or other source of gas via the dispenser vapor feed conduit 10 to pressurize each vessel for feeding the liquid 1L to one or more dispensers via the dispenser feed conduit 22 that can be connected to the dispenser feed vessel liquid conduits of those dispenser feed vessels 20.

For example, the first dispenser feed vessel 20a can receive gas via a first dispenser feed vessel vapor conduit 19a that is connected between the first dispenser feed vessel 20a and the dispenser vapor feed conduit 10. The second dispenser feed vessel 20b can receive gas via a second dispenser feed vessel vapor conduit 19b that is connected between the second dispenser feed vessel 20b and the dispenser vapor feed conduit 10. The third dispenser feed vessel 20c can receive gas via a third dispenser feed vessel vapor conduit 19c that is connected between the third dispenser feed vessel 20c and the dispenser vapor feed conduit 10. The first dispenser feed vessel gas conduit 19a can include a control valve 26a that can be adjustable between open and closed positions, the second dispenser feed vessel vapor conduit 19b can include a control valve 26b that can be adjustable between open and closed positions, and the third dispenser feed vessel vapor conduit 19c can include a control valve 26c that can be adjustable between open and closed positions to facilitate the flow of gas into the and out of the dispenser feed vessels 20.

A valve 18 can be positioned in a conduit that is position between the dispenser feed vessels 20 and the storage tank return conduit 13 and/or the second vapor recovery conduit 11 to control how gas or fluid can be output from the vessels 20 via their respective vapor conduits. For example, valves 26a, 26b, and/or 26c of the dispenser feed vessel vapor conduits 19a, 19b, 19c can be adjusted from a closed position to an open position to depressurize the vessel(s) 20 and help drive a flow of the fluid out of the dispenser feed vessels 20 and to the storage tank 1 and/or the vapor recovery mechanism 6 for recovery and/or use of the fluid. This fluid can be mostly vapor or entirely vapor and can be very cold (e.g. be vaporized liquid that is at a very cold, cryogenic temperature or near such a temperature, etc.). Any remaining liquid from within each dispenser feed vessel 20 may vaporize as it warms and/or be vaporized via the opening of the valve 18 and the reduction in pressure of the vessels 20 that may occur and that vapor can be passed out of the dispenser feed vessel(s) 20 for feeding to the tank 1 and/or the vapor recovery mechanism 6 for subsequent use.

FIG. 9 illustrates an exemplary embodiment of a conduit arrangement for the flow of liquid and vapor into and out of the dispenser feed vessels 20 that can be utilized in the embodiments of FIGS. 1-8. Other embodiments may utilize other types of conduit arrangements to account for a particular set of design criteria.

As may be seen in FIG. 9, the dispenser feed vessel conduit 25 can include different branches to permit filling of one or more of the dispenser feed vessels 20 selectively. For example, the dispenser feed vessel conduit 25 can include a first branch 25a, a second branch 25b, and a third branch 25c that each are positioned downstream of the valve 24 of the dispenser feed vessel conduit 25. The first branch 25a can include a first control valve 37a and a second control valve 49 downstream of the first control valve 37a. The second branch 25b can include a first control valve 37b and a second control valve 48 downstream of the first control valve 37a. The third branch 25c can include a first control valve 37c and a second control valve 51 downstream of the first control valve 37c.

The first branch 25a can include a first portion that extends from the first control valve 37a for being fluidly connected to the first dispenser feed vessel liquid conduit 21a. The second control valve 49 can be downstream of the location at which the first dispenser feed vessel liquid conduit 21a is connected to the first branch 25a. A second portion 54 of the first branch 25a can extend form the second control valve for connecting with the dispenser feed conduit 22 so liquid output from the first dispenser feed vessel 20a can be output from that vessel and fed to the dispenser feed conduit 22. Also, the first and second control valves 37a and 49 can be closed to isolate the first dispenser feed vessel 20a so fluid from that vessel is not passable to the dispenser feed conduit 22.

The second portion 54 of the first branch 25a can also be positioned and configured so that it can be utilized to connect the dispenser directly to the dispenser feed vessel feed conduit 25. This way a vehicle tank (e.g. fuel tank or storage tank) can be filled to a pre-selected fill level by using just the liquid from the storage tank 1 and, after that initial filing is completed, the remainder of the filling of the vehicle tank can be filled via the liquid within the dispenser feed conduits 20 (e.g. first, second, and third dispenser feed conduits 20a, 20b, 20c). For example, in some embodiments a vehicle tank may have 80% or 80%-95% of its capacity volume filled via liquid passed through the dispenser feed vessel feed conduit 25 from tank 1. The remaining 20% or 20%-5% of the capacity of the tank being filled may then be provided via liquid from the dispenser feed vessel(s) 20. This type of operation can be provided via the opening and closing of valves to facilitate the feeding of liquid from the different tanks and vessels (e.g. closing of valve 37a and opening of vale 27a). This type of functionality can help save pressurization gas, reduce the size of the tank 1 and/or reduce the generation of gas that may need to be discarded, vented, or otherwise processed once dispensing is complete.

The second branch 25b can include a first portion that extends from the first control valve 37b for being fluidly connected to the second dispenser feed vessel liquid conduit 21b. The second control valve 48 can be downstream of the location at which the second dispenser feed vessel liquid conduit 21b is connected to the second branch 25b. A second portion 53 of the second branch 25b can extend form the second control valve 48 for connecting with the dispenser feed conduit 22 so liquid output from the second dispenser feed vessel 20b can be output from that vessel 20 and fed to the dispenser feed conduit 22. Also, the first and second control valves 37b and 48 can be closed to isolate the second dispenser feed vessel 20b so fluid from that vessel is not passable to the dispenser feed conduit 22.

The second portion 53 of the second branch 25b can also be positioned and configured so that it can be utilized to connect the dispenser directly to the dispenser feed vessel feed conduit 25. This way a vehicle tank (e.g. fuel tank or storage tank) can be filled to a pre-selected fill level by using just the liquid from the storage tank 1 and, after that initial filing is completed, the remainder of the filling of the vehicle tank can be filled via the liquid within the dispenser feed conduits 20 (e.g. first, second, and third dispenser feed conduits 20a, 20b, 20c). For example, in some embodiments a vehicle tank may have 80% or 80%-95% of its capacity volume filled via liquid passed through the dispenser feed vessel feed conduit 25 from tank 1. The remaining 20% or 20%-5% of the capacity of the tank being filled may then be provided via liquid from the dispenser feed vessel(s) 20. This type of operation can be provided via the opening and closing of valves to facilitate the feeding of liquid from the different tanks and vessels (e.g. closing of valve 37b and opening of vale 27b). This type of functionality can help save pressurization gas, reduce the size of the tank 1 and/or reduce the generation of gas that may need to be discarded, vented, or otherwise processed once dispensing is complete.

The third branch 25c can include a first portion that extends from the first control valve 37c for being fluidly connected to the third dispenser feed vessel liquid conduit 21c. The second control valve 51 can be downstream of the location at which the third dispenser feed vessel liquid conduit 21c is connected to the third branch. A second portion 52 of the third branch 25c can extend form the second control valve 51 for connecting with the dispenser feed conduit 22 so liquid output from the third dispenser feed vessel 20c can be output from that vessel 20 and fed to the dispenser feed conduit 22. Also, the first and second control valves 37c and 51 can be closed to isolate the third dispenser feed vessel 20c so fluid from that vessel is not passable to the dispenser feed conduit 22.

The second portion 53 of the third branch 25c can also be positioned and configured so that it can be utilized to connect the dispenser directly to the dispenser feed vessel feed conduit 25. This way a vehicle tank (e.g. fuel tank or storage tank) can be filled to a pre-selected fill level by using just the liquid from the storage tank 1 and, after that initial filing is completed, the remainder of the filling of the vehicle tank can be filled via the liquid within the dispenser feed conduits 20 (e.g. first, second, and third dispenser feed conduits 20a, 20b, 20c). For example, in some embodiments a vehicle tank may have 80% or 80%-95% of its capacity volume filled via liquid passed through the dispenser feed vessel feed conduit 25 from tank 1. The remaining 20% or 20%-5% of the capacity of the tank being filled may then be provided via liquid from the dispenser feed vessel(s) 20. This type of operation can be provided via the opening and closing of valves to facilitate the feeding of liquid from the different tanks and vessels (e.g. closing of valve 37c and opening of vale 27c). This type of functionality can help save pressurization gas, reduce the size of the tank 1 and/or reduce the generation of gas that may need to be discarded, vented, or otherwise processed once dispensing is complete.

The vapor feed conduit 10 can also include multiple branches that can feed gas to the different dispenser feed vessels. For example, the vapor feed conduit 10 can include a first branch 10c, a second branch 10b and a third branch 10a. The first branch 10c, second branch 10b, and third branch 10a can each include multiple control valves for utilization in connection with fluidly connecting the different branches together to permit gas to be passed selectively to one or more of the dispenser feed vessels 20 based on which vessels may be filled with liquid for a particular fueling operation for feeding liquid 1L to at least one dispenser via the dispenser feed conduit 22.

For example, the first branch 10c of the vapor feed conduit 10 can include a first control valve 17c and a second control valve 60a downstream of the first control valve 17c and also downstream of a second branch connecting conduit that extends between the first and second branches 10c and 10b and has a control valve 59. The second branch connecting conduit can be positioned so gas can be passed from the first branch 10c to the second branch 10b or can be passed from the second branch 10b to the first branch 10c at a location between the first and second control valves 17c and 60a of the first branch.

The third branch 10a of the vapor feed conduit 10 can include a first control valve 17a and a second control valve 60c downstream of the first control valve 17a and also downstream of a second branch connecting conduit that extends between the third and second branches 10a and 10b and has a control valve 58. The second branch connecting conduit can be positioned so gas can be passed from the third branch 10a to the second branch 10b or can be passed from the second branch 10b to the third branch 10a at a location between the first and second control valves 17a and 60c of the first branch.

The second branch 10b of the vapor feed conduit 10 can include a first control valve 17b and a second control valve 60b downstream of the first control valve 17b and also downstream of the second branch connecting conduits that extend from the third branch 10a and the first branch 10a to the second branch 10b. The second branch connecting conduits can be connected to the second branch at locations between the first and second control valves 17b and 60b of the second branch 10b. The second branch connecting conduits can be positioned so gas can be passed between the different branches based on which of the control valves of the first, second, and third branches are opened and closed and which of the control valves 58, 59 of the second branch connecting conduits are opened or closed. Portions of gas passed through the vapor feed conduit 10 can be passed to all three branches, only one of the branches, or any two of the three branches based on the adjustment of the control positions between their open and closed positions, for example.

The first branch 10c of the vapor feed conduit 10 can be connected to the first dispenser feed vessel vapor conduit 19a at a position downstream of the second control valve 60a of the first branch 10c. The second dispenser feed vessel 20b can receive gas via a second dispenser feed vessel vapor conduit 19b that is connected to the second branch 10b of the dispenser vapor feed conduit 10 downstream of the second control valve 60b of the second branch 10b. The third dispenser feed vessel 20c can receive gas via the third dispenser feed vessel vapor conduit 19c that is connected between to the third branch 10a of the vapor feed conduit 10 downstream of the second control valve 60c of this branch. The control valve 26a of the first dispenser feed vessel gas conduit 19a can be adjustable between open and closed positions and be positioned to control whether gas from the first branch 10c is passable into the first dispenser feed vessel 20a or not. The control valve 26b of the second dispenser feed vessel vapor conduit 19b can be adjustable between open and closed positions and positioned to control whether gas from the second branch 10b is passable into the second dispenser feed vessel 20b or not. The control valve 26c of the third dispenser feed vessel vapor conduit 19c can be adjustable between open and closed positions and positioned to control whether gas passed through the third branch 10c can be fed to the third dispenser feed vessel 20c or not.

The first dispenser feed vessel vapor conduit 19a can include a vapor recycle conduit 15a that can be connected between the control valve 26a of the first dispenser feed vessel vapor conduit 19a and tank return conduit 13 and/or the second vapor recovery conduit 11 so that gas can be output from the first dispenser feed vessel 20a and be passable to the tank 1, the heat exchanger arrangement of the tank 1, and/or the vapor recovery mechanism 6. The second dispenser feed vessel vapor conduit 19b can include a vapor recycle conduit 15b that can be connected between the control valve 26b of the second dispenser feed vessel vapor conduit 19b and tank return conduit 13 and/or the second vapor recovery conduit 11 so that gas can be output from the second dispenser feed vessel 20b and be passable to the tank 1, the heat exchanger arrangement of the tank 1, and/or the vapor recovery mechanism 6. The third dispenser feed vessel vapor conduit 19c can include a vapor recycle conduit 15c that can be connected between the control valve 26c of the third dispenser feed vessel vapor conduit 19c and tank return conduit 13 and/or the second vapor recovery conduit 11 so that gas can be output from the third dispenser feed vessel 20c and be passable to the tank 1, the heat exchanger arrangement of the tank 1, and/or the vapor recovery mechanism 6.

The vapor recycle conduit 15a of the first dispenser feed vessel vapor conduit 19a, the vapor recycle conduit 15b of the second dispenser feed vessel vapor conduit 19b, and the vapor recycle conduit 15c of the third dispenser feed vessel vapor conduit 19b can each include a respective valve for controlling a flow of the vapor out of the different dispenser feed vessels 20. For example, the vapor recycle conduit 15a of the first dispenser feed vessel vapor conduit 19a can include a fist vapor recycle conduit control valve 18a, the vapor recycle conduit 15b of the second dispenser feed vessel vapor conduit 19b can include a second vapor recycle conduit control valve 18b, and the vapor recycle conduit 15c of the third dispenser feed vessel vapor conduit 19c can include a third vapor recycle conduit control valve 18c.

In some embodiments, a vent conduit 61 can be positioned so that some gas passed to the tank return conduit 13 and/or the second vapor recovery conduit 11 can be vented or passed to another unit. The vent conduit 61 can include a control valve 62 that can be adjustable between a closed position and an open position to facilitate optional venting or redirecting of vapor via the vent conduit 61.

The different dispenser feed vessels 20 can also be fluidly connected to each other to permit fluid from one vessel 20 to be passed to one or more other vessels 20. For example, the first dispenser feed vessel 20a can be fluidly connected to the third dispenser feed vessel 20c and the second dispenser feed vessel 20b via a first dispenser feed vessel interconnection conduit 39 that can be positioned between the first and third dispenser feed vessels 20a, 20c. The first dispenser feed vessel interconnection conduit 39 can include a first control valve 38a, a second control valve 57, and a third control valve 40. The second control valve 57 can be positioned to control the flow of fluid from the first dispenser feed vessel 20a to the second dispenser feed vessel 20b via a second dispenser conduit segment 41 of the first dispenser feed vessel interconnection conduit 39. The third control valve 40 can be positioned to control the flow of fluid from the first dispenser feed vessel 20a to the third dispenser feed vessel 20c via a third dispenser conduit segment 42 of the first dispenser feed vessel interconnection conduit 39. Also, fluid can be passed from the third dispenser feed vessel 20c to the first dispenser feed vessel 20a and/or the second dispenser feed vessel 20b via the first dispenser feed vessel interconnection conduit 39 based on positioning of the first, second, and third control valves 38a, 40, and 57. The fluid passed between these vessels can be liquid and/or vapor. Vessels may be equipped with a liquid inlet/withdrawal line (typically at or near the bottom) and/or a vapor inlet/withdrawal line (typically at or near the top). Any vessel may have the ability to flow liquid or vapor to any other vessel's liquid or vapor connection.

There can be a second dispenser feed vessel interconnection conduit 45 positioned to connect the third dispenser feed conduit 20c to the second dispenser feed conduit 20b. The second dispenser feed vessel interconnection conduit 45 can also be connected to the first dispenser feed vessel interconnection conduit 39 via the second dispenser conduit segment 41 in some embodiments. The second dispenser feed vessel interconnection conduit 45 can include a third dispenser feed vessel control valve 38c, a second dispenser feed vessel control valve 43, and an additional second dispenser feed vessel control valve 38b. These valves can be adjustable between open and closed positions to direct fluid from one of the vessels 20 to another one of the vessels or to multiple other vessels 20.

In some embodiments, there can be at least one third dispenser feed vessel interconnection conduit that can include control valves 55, 44, 56, and 47 for selectively controlling how fluid may be passed between the first, second, and third dispenser feed vessels 20a, 20b, and 20c as well.

The dispenser feed vessel interconnection conduits can be provided so that fluid from the different tanks can be fed to other dispenser feed vessels 20 to utilize that fluid in the pressurization of the other vessels 20. For instance, after the first dispenser feed vessel 20a has its liquid output via pressurization of that vessel, the remaining fluid in the vessel can be driven to the second dispenser feed vessel 20b to help pressurize that vessel for subsequently sending the liquid of that vessel 20b to the dispenser(s). After the liquid of the second dispenser feed vessel 20b has been passed to the dispenser(s), fluid that may remain in the second dispenser feed vessel 20b can subsequently be fed to the third dispenser feed vessel 20c to help pressurize that vessel as well. The remaining fluid of the different dispenser feed vessels that may be utilized to help pressurize other dispenser feed vessels can be colder than other gas that may subsequently be fed to the dispenser feed vessel(s) 20 for pressurization and can be introduced first into a vessel to provide a heat exchange buffer to help slow or limit any heating that may occur from the pressurization of a vessel 20. This may help limit loss of liquid to vaporization so that the capacity of the vessel(s) 20 can be more effectively and flexibly utilized.

In the same way liquid from one vessel can be transferred to any other. This liquid can be added either to the vapor or liquid port of any other vessel. This is useful to help cool down the gas in the tank and decrease the pressure prior to refilling. This type of functionality can also help cool down the dispenser feed vessel(s) 20 itself before it is filed with liquid from the tank 1 so that less vapor may be generated when the dispenser feed vessel(s) 20 are filled with liquid from the tank 1.

The exemplary conduit arrangement and dispenser feed vessel arrangement illustrated in FIG. 9 can be adjusted to account for different design criteria. The number and positioning of control valves, the number of branches of the vapor feed conduit 10 and/or the liquid feed conduit 25, as well as the number of dispenser feed vessels 20 can be any suitable number and arrangement for a particular set of design criteria. Also, the size and configuration of the tank 1, vessels 20, or conduits can be of different shape and sizes and can also be configured for utilization at different pressurization ranges and/or temperature ranges. Each dispenser feed vessel 20 can be filled with a liquid to different levels as may be needed for a particular application for subsequent pressurization via gas. The sizing of the dispenser feed vessels 20 can also be adapted to account for a particular set of design objectives that include accounting for the pre-selected liquid fill levels for the vessels.

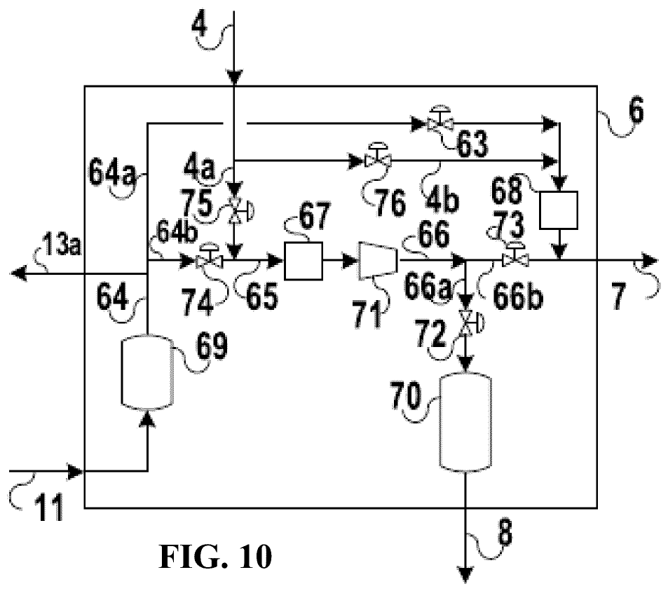

Referring to FIG. 10, the vapor recovery mechanism 6 can include a number of different elements to facilitate the storage and use of gas that may be output from the tank 1, the dispenser feed vessel(s) 20, and/or the heat exchanger arrangement HX that may be positioned in the tank 1. For example, the vapor recovery mechanism 6 can include at least one vaporizer and/or at least one buffer tank (e.g. at least one flash tank). The vapor recovery mechanism 6 can also include a conduit arrangement for facilitating the flow of vapor from the tank 1 and/or heat exchanger arrangement HX of the tank to the one or more dispenser feed vessels 20 for pressurization of the vessel(s) 20. In some embodiments, the vapor recovery mechanism 6 can also include a compressor for feeding the vapor to the one or more dispenser feed vessels 20 for pressurization of the vessel(s) 20. The compressor that may be utilized can be a mechanical compressor, an electrochemical compressor, a thermocompressor (e.g. a compressor configured to provide a pressure rise due to heat input), or any other means of increasing pressure. In some embodiments, a compressor can also be used to pressurize the gas before sending it somewhere via gas outlet conduit 7 (e.g. sending the gas to a pipeline, etc.).

For instance, the vapor recovery mechanism 6 can include a vapor recovery feed conduit 4a that can be a portion of the first vapor recovery conduit 4 or connected to the first vapor recovery conduit 4 for feeding the vapor output from the tank 1 and/or heat exchanger arrangement HX of the tank 1 to the vapor recovery mechanism 6. The vapor recovery feed conduit 4a can feed vapor to a compressor 71 and/or at least one buffer tank 70 for storage of the vapor for feeding to the one or more dispenser feed vessels 20 for pressurization of the vessel(s) 20.

In some embodiments, the vapor recovery feed conduit 4a can have at least one control valve for controlling how the vapor may be routed to different elements of the vapor recovery mechanism 6. For instance, the vapor recovery feed conduit 4a can have a first control valve 75 and a second control valve 76. The first control valve 75 can be positioned to control a flow of vapor to the compressor 71 and/or buffer tank 70. The second control valve 76 can be positioned for a buffer tank bypass conduit 4b of the vapor recovery mechanism 6 to control a flow of the vapor that can be directed to a gas outlet conduit 7 for directing some vapor to a dispenser that may be configured to dispense gas (e.g. a hydrogen gas dispenser), or to a downstream unit that may utilize the gas (e.g. a fuel cell FC, etc.), or to a hydrogen gas storage unit for subsequent use (e.g. for supplying hydrogen gas to the vapor feed conduit 10). The vapor recovery mechanism 6 can optionally include a gas outlet conduit heater or vaporizer 68 for heating the gas passed through the buffer tank bypass conduit 4b for feeding to the gas outlet conduit 7 in some embodiments so that the output gas can be fully gaseous and/or be at a pre-selected temperature or within a pre-selected temperature range.

The first and second control valves 75 and 76 of the vapor recovery feed conduit 4a can be adjusted between their open and closed positions to control an amount of the gas that may be fed to the buffer tank 70 or the gas outlet conduit 7 of the vapor recovery mechanism 6. Gas passed through the first control valve 75 can be fed to a buffer tank feed conduit 65 that can be positioned to optionally feed the gas to a heater or vaporizer 67 and/or compressor 71 (which can be positioned downstream of the optional heater or vaporizer 67) for feeding the gas to buffer tank 70. The buffer tank 70 can be connected to a buffer tank feed conduit 66a that can have a control valve 72 positioned between the compressor 71 and/or first control valve 75 and the gas outlet conduit 7 of the vapor recovery mechanism. In situations where the buffer tank may be full or where it may not be desired to feed vapor to the buffer tank 70, the control valve 72 of the buffer tank feed conduit 66a can be closed so that the gas passed through the first control valve 75 (and optionally the heater or vaporizer 67 and/or compressor 71) can be passed to the gas outlet conduit 7 via a gas outlet conduit connecting conduit 66b. The gas outlet conduit connecting conduit 66b can have a control valve 73 positioned downstream of the buffer tank feed conduit 66a so it can be opened to permit gas to pass to the gas outlet conduit 7 when the control valve 72 of the buffer tank feed conduit 66a is closed.

In some embodiments, the vapor recovery mechanism 6 can also include vapor return recovery elements for receipt of vapor, or gas, output from the dispenser feed vessel(s) 20 and fed to the vapor recovery mechanism 6 via the second vapor recovery conduit 11. For example, the vapor recovery mechanism 6 can include a buffer tank 69 that is fluidly connectable to the second vapor recovery conduit 11 to receive and store gas received via the second vapor recovery conduit 11. The optional buffer tank 69 can be connected to a buffer tank output conduit 64 that can route the vapor of the buffer tank 69 to tank feed conduit 13a to feed vapor to the tank 1 and/or heat exchanger arrangement HX of the tank 1. The buffer tank 69 can also be connected to the buffer tank output conduit 64 to feed the vapor to a feed dispenser buffer tank feed conduit 64b for feeding gas to the buffer tank 70 that can be connected to the vapor recovery mechanism output conduit 8 for feeding vapor to the dispenser feed vessel(s) 20 (e.g. via the vapor feed conduit 10). The buffer tank 69 can also be connected to the buffer tank output conduit 64 to feed the vapor to the gas outlet conduit 7 via a gas outlet conduit connecting conduit arrangement 64a that can be positioned between the buffer tank output conduit 64 and the gas outlet conduit 7. In some embodiments, the conduit arrangement can be configured so that utilization of buffer tank 69 is optional (e.g. may be bypassed) so that these elements are only utilized if desired or needed.

The gas outlet conduit connecting conduit arrangement 64a can include a control valve 63 and/or the feed dispenser buffer tank feed conduit 64b can include a control valve 74. Each control valve can be adjustable between open and closed positions to control whether (or how much) of the gas output from the buffer tank 69 can be fed to the buffer tank 70, to the gas outlet conduit 7, and/or to the tank feed conduit 13a.

In some embodiments, the feed dispenser buffer tank feed conduit 64b can be positioned so that gas passed through this conduit can be fed to a heater or vaporizer 67 and/or compressor 71 for feeding the gas to buffer tank 70. The gas outlet conduit connecting conduit arrangement 64a can be positioned and configured in some embodiments to feed gas passed through this conduit to the heater or vaporizer 68 that may be positioned upstream of the gas outlet conduit 7 in some embodiments.

The heater or vaporizer 67 and the heater or vaporizer 68 can each be a type of heat exchanger. Each heater or vaporizer 67, 68 can be an ambient air vaporizer or a cooling water vaporizer that may heat the gas passed through the vaporizer via the heating medium (e.g. air, water, ambient temperature hydrogen from a nearby fueling station, ambient helium gas, etc.). The gas passed through each vaporizer may not need vaporized such that the vaporizer can function as a heater for heating the gas. In some embodiments, the conduit arrangement can be configured so that utilization of heater or vaporizer 67 and/or use of heater or vaporizer 68 is optional (e.g. each or both of these elements may be bypassed) so that these elements are only utilized if desired or needed.

Each dispenser feed vessel 20 can have an internal configuration to help facilitate the pressurization of the liquid 1L that can be fed therein for driving a flow of the liquid out of the vessel 20 and to the dispenser(s) via the dispenser feed conduit 22. For instance, the vessel(s) 20 can include baffles 20bf positioned in a chamber of the vessel. The baffles 20bf can have holes 20bh as may best be seen in FIG. 12. The baffles 20bf can be stainless steel, metal, ceramic, polymeric, and/or composite baffles. In some embodiments, the baffles 20bf can include vacuum insulated pockets inside them.

The baffles 20bf can be positioned to horizontally extend or extend at an angle relative to horizontal from within the vessel in which the baffles 20bf are positioned (e.g. the baffles can extend horizontally or at a pre-selected pitch relative to horizontal). The baffles 20bf can be configured to help provide a more uniform flow of gas into the vessel for pressurizing the vessel 20 and to help limit the interaction between the gas and liquid to minimize any heating that may occur from the pressurization of the vessel 20. The baffles 20bf can be positioned so that there are numerous rows of vertically spaced apart baffles and that terminal ends of baffles are spaced a pre-selected distance a form a sidewall of the vessel 20 to provide a desired flow pattern within the vessel 20.

In other embodiments, each dispenser feed vessel 20 can have a distributor plate 20dp positioned in an upper region of the vessel above an upper liquid fill line of the vessel to help guide the gas passed into the vessel for providing a more uniform pressurization of the vessel via the gas and to help limit the gas interacting with the liquid at the upper liquid fill line within the vessel. In some embodiments, the distributor plate 20 db can be configured as ASU packing, at least one plate have a pre-selected arrangement of apertures, or have another type of suitable distributor plate configuration that can help guide the gas passed into the vessel for providing a more uniform pressurization of the vessel via the gas and to help limit the gas interacting with the liquid at the upper liquid fill line within the vessel.

In yet other embodiments, the one or more dispenser feed vessels 20 may not utilize a distributor plate and/or baffles 20bf. In yet other embodiments, the dispenser feed vessel(s) 20 may utilize both a distributor plate 20dp and baffles 20bf.

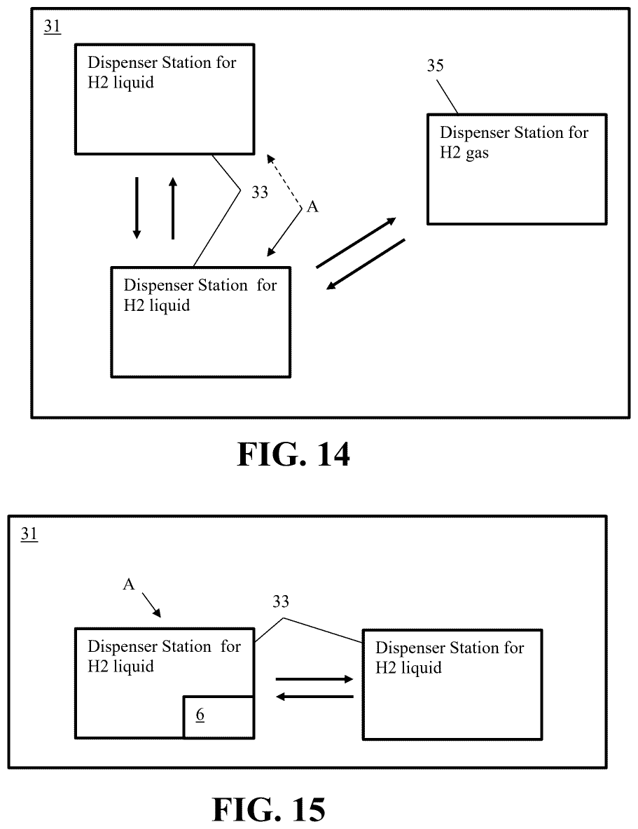

Embodiments of the apparatus A can be positioned at one or more dispenser stations of a fueling station. FIGS. 14 and 15 illustrate different exemplary arrangements in which at least one apparatus A can be utilized in conjunction with supporting dispenser fueling operations.

For instance, FIG. 14 illustrates a fueling station 31 that has multiple dispenser stations for liquid hydrogen (H2 liquid) 33. Each dispenser of the dispenser station for liquid hydrogen 33 can include a dispenser having a nozzle for feeding liquid hydrogen into a vehicle fuel tank. At least one of these dispenser stations for liquid hydrogen can have an apparatus A dedicated to operation of the dispensers at the station. The fueling station 31 can also include at least one dispenser station for hydrogen gas (H2 gas) 35. Such a dispenser station can include dispensers configured to feed hydrogen gas into a fuel tank of a vehicle.

The apparatus A can be positioned and configured to receive vapor from the dispenser feed vessel(s) 20 associated with different dispensers of the different dispenser stations for liquid hydrogen 33 for use of the vapor to pressurize the vessels to facilitate feeding of liquid hydrogen to dispensers for filling fuel tanks. Also, at least some of the vapor that is recovered via the vapor recovery mechanism 6 of the apparatus A can be provided to support hydrogen gas dispensing of the hydrogen gas dispensers via the gas outlet conduit 7 of the vapor recovery mechanism 6. FIGS. 14 and 15 illustrate different exemplary configurations that can facilitate this type of operation of the apparatus A. This can permit one or more apparatuses A of a fueling station 31 to support different dispenser stations of the fueling station for dispensing of liquid hydrogen and/or gaseous hydrogen.

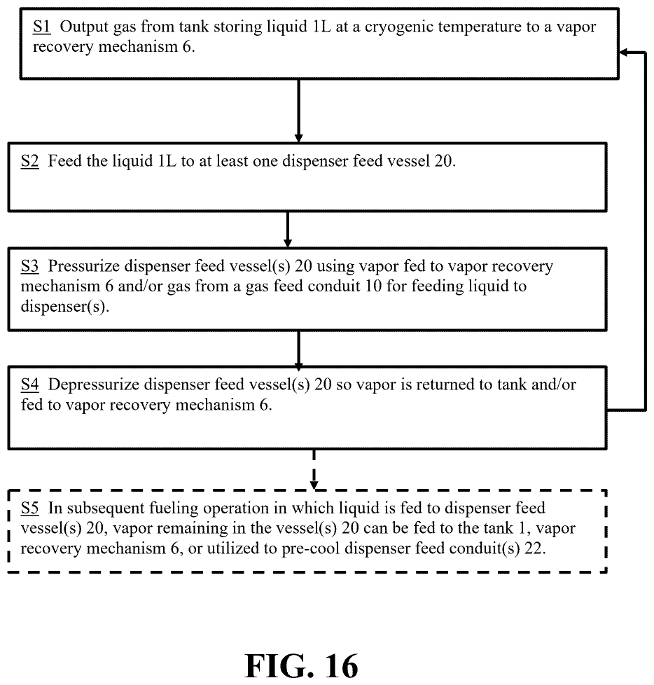

FIG. 16 illustrates an exemplary embodiment of a process for recovering vapor and/or using gas to pressurize one or more dispenser feed vessels for feeding liquid fuel (e.g. liquid hydrogen) to one or more dispensers via at least one dispenser feed conduit 22 connected between the dispenser feed vessel(s) 20 and the dispenser(s). Embodiments of the apparatus A discussed above can be utilized to implement an embodiment of the process (which can also be referred to as a method).

In a first step S1, liquid 1L stored in the tank at a cryogenic temperature (e.g. liquid hydrogen) can have gas 1G output from the tank 1 and passed to the vapor recovery mechanism 6. Liquid 1L can also be fed from the tank 1 to at least one dispenser feed vessel 20 for being utilized to feed the liquid (e.g. liquid hydrogen) to one or more dispensers for at least partially filling at least one vehicle fuel tank in a second step S2. In some embodiments, some vapor that may be retained in a buffer tank 70 of the vapor recovery mechanism 6 can be fed to the dispenser feed vessel(s) 20 prior to liquid 1L being fed to the vessel(s) 20 to help cool the vessel(s) to limit or minimize vaporization of liquid that may occur when the liquid is fed to the vessel(s) 20.

After the dispenser feed vessel(s) 20 are sufficiently filled, gas from a gas feed conduit 10 and/or the vapor recovery mechanism 6 can be fed to the dispenser feed vessel(s) 20 to pressurize the vessel(s) for feeding the liquid 1L to the dispensers (e.g. via the dispenser feed conduit(s) 22 in a third step S3.

After the fueling is completed, the dispenser feed vessel(s) 20 can be depressurized in a fourth step S4 such that vapor output from the vessel(s) can be vented, returned to the tank 1, returned to the tank 1 by being fed to tube(s) TB of a heat exchanger arrangement HX positioned in the tank 1, and/or fed to the vapor recovery mechanism 6 for being re-used in subsequent pressurization operations or for being output to a gas output conduit 7 for otherwise stored or used as discussed above.

In some embodiments, a subsequent fueling can be provide in which liquid 1L is fed to the depressurized dispenser feed vessel(s) 20 and some vapor present in the vessel(s) 20 can be displaced out of the vessel(s) 20 for being fed to the tank or vapor recovery mechanism 6 in a fifth step S5. In some embodiments, the displaced vapor may be routed to provide pre-cooling to the dispenser feed conduit(s) 22 instead of being fed to the tank 1 or the vapor recovery mechanism 6.

Embodiments of our apparatus and process can provide significant advantages. For example, embodiments can avoid use of a pump for vehicle fueling operations or can be configured so that only intermittent use of an auxiliary pump is needed for a small portion of the fueling (e.g., for a final fueling stage of fueling). The avoidance of pump usage and/or minimal pump usage can reduce the need for maintenance as pump usage can be avoided or greatly reduced. Because the pump can be avoided or may only be utilized for a small portion of the fueling of a vehicle fuel tank, there can also be substantially less power consumption and a significant avoidance of fugitive emissions can be provided. Also, pump and conduit cooldown time and pressure equalization delay times for fueling can be avoided or greatly minimized. Additionally, embodiments can permit boil off loss capture during fueling as well as during storage of the fluid within the tank 1 to greatly reduce loss of cryogenic fluid. These improvements can provide significant operational cost reductions as well as avoiding cryogenic fluid losses and power reduction. These types of improvements can also facilitate a more economical and environmentally friendly operation for cryogenic fluid vehicle fueling systems.

Additional benefits that can be provided can include sizing of any type of pump that may be used in the apparatus A. The auxiliary pump can be smaller so that the capital and operational costs associated with any use of the pump (for embodiments that may utilize the auxiliary pump) can be significantly reduced.

Also, embodiments can facilitate the filling of vehicle tanks with liquid hydrogen or other liquid cryogenic fuel (e.g. liquid natural gas). Embodiments can be configured so that the liquid is fed to the fuel tank at a pressure that is over its critical pressure while also being at a temperature that is under its critical temperature. The feeding of liquid can permit fuel tanks to require less volume for storage of fuel and/or to have a larger effective storage capacity. This type of functionality may also permit fueling operations to occur more quickly.

Some of the exemplary embodiments discussed herein relate to utilization of hydrogen as a fuel source (e.g. feeding of liquid hydrogen to a fuel tank of a vehicle or a storage tank of a vehicle (e.g. a tank of a transportation vehicle, etc.). Hydrogen suitable for fueling or suitable for filling a tank for transport is relatively pure in accordance with pre-defined hydrogen fueling standards or hydrogen transport standards. For hydrogen fueling situations, the impurity content within such hydrogen is very low in accordance with applicable hydrogen fuel standards, for example. Hydrogen that can be stored for use in fueling of a vehicle is an example of a cryogenic fluid. Other embodiments of the apparatus can be utilized with other types of cryogenic fluid (e.g., cryogenic liquid and/or cryogenic gas) instead of hydrogen gas and/or liquid hydrogen. For example, the tank 1 can retain another type of cryogenic fluid (e.g. cryogenic natural gas, liquid methane, liquid oxygen, liquid nitrogen, liquid argon, etc.). It should therefore be understood that the hydrogen fueling or filing of a hydrogen transportation trailer tank exemplary embodiments discussed herein are examples and that other embodiments and uses are also contemplated in addition to use in hydrogen fueling station type environments. In such non-hydrogen fueling embodiments, the pre-selected temperature and pressure for the tank 1 may differ to account for the different cryogenic fluid (e.g., the temperature can be less than a boiling point for the fluid so the fluid is maintainable as a liquid) as also noted above.

It should also be appreciated that other modifications to the embodiments explicitly shown and discussed herein can be made to meet a particular set of design objectives or a particular set of design criteria. For instance, the arrangement of valves, piping, and other conduit elements (e.g. conduit connection mechanisms, tubing, seals, etc.) for interconnecting different units of the apparatus for fluid communication of the flows of fluid between different units can be arranged to meet a particular layout design that accounts for available area of the cryogenic fluid dispensing, sized equipment of the system, and other design considerations. As another example, the flow rate, pressure, and temperature of the fluid passed through the different elements of the apparatus as well as passed through other apparatus elements can vary to account for different cryogenic fluid storage and use system design configurations and other design criteria. As yet another example, the material composition for the different structural components of the apparatus can be any type of suitable materials as may be needed to meet a particular set of design criteria. As yet another example, embodiments can utilize a particulate type of automated process control system and/or a distributed control system (DCS) to meet a particular set of design criteria for a particular embodiment.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of our apparatuses for cryogenic fluid dispensing, processes for cryogenic fluid dispensing, and methods of making and using the same have been shown and described above, it is to be distinctly understood that the invention is not limited thereto but may be otherwise variously embodied and practiced within the scope of the following claims.

What is claimed is:

1. A cryogenic fluid dispensing apparatus comprising:
a tank positioned and configured to retain a cryogenic liquid, a cryogenic gas being formable in the tank while the tank stores the cryogenic liquid;
the tank fluidly connected to at least one dispenser feed vessel so that the cryogenic liquid within the tank is feedable to the at least one dispenser feed vessel;
the at least one dispenser feed vessel being fluidly connected to a vapor recovery mechanism and/or a source of gas so that the gas from the source of gas and/or the cryogenic gas of the tank is feedable to the at least one dispenser feed vessel to at least help pressurize the at least one dispenser feed vessel to feed the cryogenic liquid within the at least one dispenser feed vessel to a dispenser feed conduit for feeding to at least one dispenser.

2. The cryogenic fluid dispensing apparatus of claim 1, wherein the tank has at least one tube of a heat exchanger arrangement positioned in the tank, the at least one tube being fluidly connectable to the at least one dispenser feed vessel so that vapor of the at least one dispenser feed vessel is feedable to the at least one tube.

3. The cryogenic fluid dispensing apparatus of claim 2, wherein the at least one dispenser feed vessel is positioned and configured to feed the vapor to the at least one tube during depressurization of the at least one dispenser feed vessel.

4. The cryogenic fluid dispensing apparatus of claim 1, wherein the at least one dispenser feed vessel is positioned and configured to feed vapor from the at least one dispenser feed vessel to the vapor recovery mechanism.

5. The cryogenic fluid dispensing apparatus of claim 1, wherein the at least one dispenser feed vessel is positioned and configured to feed vapor from the at least one dispenser feed vessel to the vapor recovery mechanism during depressurization of the at least one dispenser feed vessel.

6. The cryogenic fluid dispensing apparatus of claim 1, wherein the tank has at least one tube of a heat exchanger arrangement positioned in the tank, the at least one tube being fluidly connectable to the at least one dispenser feed vessel so that vapor of the at least one dispenser feed vessel is feedable to the at least one tube, a portion of the at least one tube being positioned below an interface between the cryogenic liquid and the cryogenic gas in the tank; and
wherein the at least one dispenser feed vessel is positioned and configured to feed the vapor to the at least one tube during depressurization of the at least one dispenser feed vessel.

7. The cryogenic fluid dispensing apparatus of claim 1, wherein:
the tank is connected to the vapor recovery mechanism so that the cryogenic gas within the tank is feedable to the vapor recovery mechanism; and
the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser; and
the vapor recovery mechanism has a gas outlet conduit positioned to pass a portion of the cryogenic gas to a storage device, a fuel cell, or a gaseous dispenser.

8. The cryogenic fluid dispensing apparatus of claim 1, wherein:
the tank is connected to the vapor recovery mechanism so that the cryogenic gas within the tank is feedable to the vapor recovery mechanism;
the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser; and
the vapor recovery mechanism includes a buffer tank positioned to receive and retain the cryogenic gas.

9. The cryogenic fluid dispensing apparatus of claim 1, wherein:
the tank is connected to the vapor recovery mechanism so that the cryogenic gas within the tank is feedable to the vapor recovery mechanism;
the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser; and
the vapor recovery mechanism includes a compressor positioned to compress the cryogenic gas and feed the compressed cryogenic gas to a buffer tank connected to the at least one dispenser feed vessel so that the cryogenic gas is feedable to the at least one dispenser feed vessel.

10. The cryogenic fluid dispensing apparatus of claim 1, wherein the cryogenic liquid is liquid hydrogen and the cryogenic gas is hydrogen gas.

11. The cryogenic fluid dispensing apparatus of claim 1, wherein the tank has at least one tube of a heat exchanger arrangement positioned in the tank, the at least one tube being fluidly connectable to the at least one dispenser feed vessel so that vapor of the at least one dispenser feed vessel is feedable to the at least one tube, the at least one tube also being fluidly connectable to the vapor recovery mechanism to feed the vapor from the at least one tube to the vapor recovery mechanism after the vapor has passed through the at least one tube.

12. The cryogenic fluid dispensing apparatus of claim 1, wherein:
the tank is connected to the vapor recovery mechanism so that the cryogenic gas within the tank is feedable to the vapor recovery mechanism;
the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser; and
the at least one dispenser feed vessel is fluidly connected to the vapor recovery mechanism so that the cryogenic liquid is feedable to the dispenser feed conduit for feeding to at least one dispenser without use of a pump.

13. The cryogenic fluid dispensing apparatus of claim 1, wherein the at least one dispenser feed vessel includes baffles and/or a distributor plate.

14. The cryogenic fluid dispensing apparatus of claim 1, wherein:
the tank is connected to the vapor recovery mechanism so that the cryogenic gas within the tank is feedable to the vapor recovery mechanism; and
the at least one dispenser feed vessel is fluidly connected to the vapor recovery mechanism so that the cryogenic gas feedable to the vapor recovery mechanism is feedable to the at least one dispenser feed vessel to at least help pressurize the at least one dispenser feed vessel to feed the cryogenic liquid within the at least one dispenser feed vessel to the dispenser feed conduit for feeding to at least one dispenser.

15. A process for cryogenic fluid dispensing, comprising:
feeding vapor from a tank that retains a cryogenic liquid to a vapor recovery mechanism;
feeding the cryogenic liquid from the tank to at least one dispenser feed vessel;
after the at least one dispenser feed vessel is sufficiently filled with the cryogenic liquid from the tank, pressurizing the at least one dispenser feed vessel with gas to feed the cryogenic liquid to at least one dispenser for filling a tank of a vehicle with the cryogenic liquid.

16. The process of claim 15, wherein the gas utilized to pressurize the at least one dispenser feed vessel includes the vapor fed to the vapor recovery mechanism.

17. The process of claim 15, wherein the gas utilized to pressurize the at least one dispenser feed vessel also includes gas from at least one storage device.

18. The process of claim 15, comprising:
depressurizing the at least one dispenser feed vessel so that fluid from the at least one dispenser feed vessel is feedable to the tank or a heat exchanger arrangement positioned in the tank.

19. The process of claim 15, comprising:
depressurizing the at least one dispenser feed vessel so that fluid from the at least one dispenser feed vessel is feedable to the vapor recovery mechanism.

20. The process of claim 19, wherein the depressurizing of the at least one dispenser feed vessel is also performed such that the fluid from the at least one dispenser feed vessel is also feedable to the tank or a heat exchanger arrangement positioned in the tank.
